(19) United States
(12) Patent Application Publication
(10) Pub. No.: US 2014/0101279 A1
(43) Pub. Date: Apr. 10, 2014

(54) SYSTEM MANAGEMENT METHOD, AND COMPUTER SYSTEM

(71) Applicants: Akihisa Nagami, Tokyo (JP); Atsumi Terayama, Tokyo (JP); Noriko Nakajima, Tokyo (JP); Toshio Otani, Tokyo (JP)

(72) Inventors: Akihisa Nagami, Tokyo (JP); Atsumi Terayama, Tokyo (JP); Noriko Nakajima, Tokyo (JP); Toshio Otani, Tokyo (JP)

(73) Assignee: Hitachi, Ltd., Chiyoda-ku, Tokyo (JP)

(21) Appl. No.: 13/695,575

(22) PCT Filed: Oct. 4, 2012
(86) PCT No.: PCT/JP2012/006404

§ 371 Date: Feb. 11, 2013

(51) Int. Cl. H04L 29/08

(52) U.S. Cl. CPC H04L 67/1097
USPC 709/213

(57) ABSTRACT

A computer system comprising a storage device including a copy pair of a copied volume and a host computer is provided. The management computer detects a change in the state obtained by monitoring the state of the copy pair, and according to the result of detection, changes the configuration of a cluster constituted by a virtual machine using data stored in the volume, and a host computer using the volume.

### TECHNICAL FIELD

The present invention relates to a system management method and a computer system. For example, the present invention relates to management of a volume of a storage device in a computer system and a server accessing the volume.

### BACKGROUND ART

In recent years, the amount of information dealt with in a computer has been dramatically increasing, and in line with this, data center hosting hosts and/or storages that perform data processing are becoming larger. Servers, storage systems, and networks installed in a data center have experienced evolutions in techniques to cut management costs for their respective individual devices.

Along with gaining higher-performance by the servers as single entities, an architecture has begun to be adopted in which a virtualization mechanism is installed in a highly integrated blade-type device, and that can achieve load distribution among a plurality of servers. The storage systems are not designed to store large-capacity data in multiple small type storages, but store large-capacity data in a concentrated manner in a high-performance, highly reliable and, highly available large storage system.

As one of techniques that achieves a large-scale storage system, there is a storage area network. Those computer systems have widely become common in which one or more storage systems and a plurality of host machines are connected via a storage area network and a plurality of host machines share a mass memory system comprising one or more storage systems.

Such computer systems have an advantage in that it is easy to subsequently add, delete or replace storage resources or computer resources, achieving superior extendibility. As a storage system that connects to SAN, storage systems having a memory device of Redundant Array of Independent Disks (RAID) configuration are utilized in general.

Further, in addressing faults of storage systems and faults of data centers as a whole, remote copy techniques are widely common that copy data among a plurality of storage devices and that can retain data copied in a plurality of sites.

PTL 1 discloses a method for a computer system comprising a plurality of physical servers and a storage device in which when load disproportion is caused, the transfer of volumes and the transfer of the virtual server are controlled to proceed in conjunction with one another in consideration of the performance of the system as a whole, and the destination of migration from the virtual server is determined for each disk I/O path of the storage and migration takes place in a aggregated manner when the performance is deteriorated.

### CITATION LIST

### Patent Literature

PTL 1: U.S. Pat. No. 8,127,092

### SUMMARY OF INVENTION

### Technical Problem

In data centers being assembled over wide areas in precaution to a fault of a data center upon a hazard and data of storage being copied among the data center, there are growing needs for continuing operations being executed in a host machine, in addition to data protection and needs for correcting load disproportion among data centers while continuing the operation. On the other hand, there is a problem in which wide area networks connecting the data centers have narrow bands in comparison with the network in the data center (narrow area network), and the wide area network becomes the bottleneck to decline the performance when the site accessing the storage volume is different from the site of the host computer that is the origin of the access. In particular, there is a problem in which, even when the data center is designed not to pressure the wide area network in a normal time, when a fault occurs in the storage device and only the storage failed over to another site, access from the virtual server bypasses the wide area network, which leads to performance degradation.

In this respect, PTL 1 discloses a method in an environment in which there are a host computer on which a virtual server is operating and a storage device in which the virtual disk is stored, the performance is improved by transferring the virtual server and the volume to a portion where the performance load is low, when performance of the host computer and the storage device deteriorate.

However, in PTL 1, there is a problem in which since the virtual server and the volume are transferred after detection of the performance deterioration, performance deterioration for a certain period is inevitable, and the time to improve performance is long since data copy is performed after the destination of the transfer is determined. Further, there is a problem in which although the measure against performance fault can be taken, there is a possibility that data of volume at origin of transfer (destination of changeover) cannot be read where the fault is a single device fault, and it does not serve as a measure for availability improvement.

Where the failover takes place as described above, it is a rare case where performance degradation takes place immediately after change of the access path from the server to the volume, and the wide area network becomes a bottleneck during usage. Therefore, in this case, after volume is transferred (changed over), server is transferred to the host computer of another data center after detecting performance degradation. However, also in this case, there is a problem in which time to improve performance becomes long.

The present invention is made in view of the above-stated circumstances, and provides a technique that allows the continuation of operation, and enables reducing time duration of performance degradation in an environment in which volumes are copied and stored over a plurality of storage devices connected via wide area network even when a fault has occurred.

### Solution to Problem

In order to overcome the above-described problem, according to the present invention, a computer system includes a plurality of storage devices, a plurality of host computers and a management computer. The management computer comprises a memory that stores predetermined management information, and a processor that reads the predetermined management information from the memory and that manages a process in the host computer and the storage device by using the predetermined management information. In the plurality of storage devices, a copy pair is created between a storage area of a first storage device and a storage area of a second storage device, and duplicate data of data stored in the storage area of the first storage device is stored in the storage area of the second storage device. In this case, the processor of the management computer, triggered by an event that a copy pair state has been changed between the storage areas of the first and second storage devices, changes over an access destination of a first host computer from the storage area of the first storage device which is connected to the first host computer via a first communications network to the storage area of the second storage device which is connected to the first host computer via a second type communications network. Then, the processor changes over an access origin of the second storage device from the first host computer to a second host computer connected to the second storage device via the first type communications network to the second storage device.

### Advantageous Effects of Invention

According to one aspect of the present invention, in an environment in which volumes are copied on a plurality of storage devices, even when a fault has occurred, continuing operation is possible, and time duration of performance degradation can be reduced by disposing a virtual machine, and a volume in such a manner as to avoid bottleneck of the wide area network of a narrow band.

### BRIEF DESCRIPTION OF DRAWINGS

FIG. 1 is a diagram showing an exemplary overall configuration of a computer system according to the first embodiment of the present invention.

FIG. 2 is a diagram showing one exemplary hardware configuration of a management computer of the first embodiment.

FIG. 3 is a diagram showing one example of the stored information (software configuration) of a nonvolatile memory device of the management computer of the first embodiment.

FIG. 4 is a diagram showing one exemplary hardware configuration of a storage device of the first embodiment.

FIG. 5 is a diagram showing one example of the stored information (software configuration) of a nonvolatile memory device of the storage device of the first embodiment.

FIG. 6 is a diagram showing one exemplary hardware configuration of a host computer of the first embodiment.

FIG. 7 is a diagram showing one example of the information (software configuration) stored in the nonvolatile memory device of the host computer of the first embodiment.

FIG. 8 is a diagram showing one exemplary hardware configuration of a SAN connection device of the first embodiment.

FIG. 9 is a diagram showing one example of the information (software configuration) stored in the nonvolatile memory device of the SAN connection device of the first embodiment.

FIG. 10 is a diagram showing one exemplary hardware configuration of a LAN connection device of the first embodiment.

FIG. 11 is a diagram showing one example of information (software configuration) stored in the nonvolatile memory device of the LAN connection device of the first embodiment.

FIG. 12 is a diagram showing an exemplary configuration of a host computer management table in the management computer of the first embodiment.

FIG. 13 is a diagram showing an exemplary configuration of a virtual machine management table in the management computer of the first embodiment.

FIG. 14 is a diagram showing an exemplary configuration of a storage device management table in the management computer of the first embodiment.

FIG. 15 is a diagram showing an exemplary configuration of a volume management table in the management computer of the first embodiment.

FIG. 16 is a diagram showing an exemplary configuration of a LAN connection management table of the management computer of the first embodiment.

FIG. 17 is a diagram showing an exemplary configuration of a SAN connection management table in the management computer of the first embodiment.

FIG. 18 is a diagram showing an exemplary configuration of a wide area network management table in the management computer of the first embodiment.

FIG. 19 is a diagram showing an exemplary configuration of a storage device volume management table in the storage device of the first embodiment.

FIG. 20 is a diagram showing an exemplary configuration of a storage device copy pair management table of the storage device of the first embodiment.

FIG. 21 is a diagram showing an exemplary configuration of a SAN port connection management table of the SAN connection device of the first embodiment.

FIG. 22 is a diagram showing an exemplary configuration of a SAN port performance management table of the SAN connection device of the first embodiment.

FIG. 23 is a diagram showing a configuration of a LAN port connection management table in the LAN connection device of the first embodiment.

FIG. 24 is a diagram showing a configuration of a LAN port performance management table of the LAN connection device of the first embodiment.

FIG. 25A is a diagram showing an exemplary logical configuration (1) in the computer system of the first embodiment.

FIG. 25B is a diagram showing an exemplary logical configuration (2) in the computer system of the first embodiment.

FIG. 26 is a flowchart for explaining the process (overview of the whole process) on a fault of the storage device of the first embodiment.

FIG. 27 is a flowchart for explaining the details of the process to determine an allocation of the virtual machine according to the first embodiment.

FIG. 28 is a flowchart for explaining the details of the processes to transfer the virtual machine according to the first embodiment.

FIG. 29 is a diagram showing an exemplary configuration of a storage management table of the management computer according to the second embodiment.

FIG. 30 is a diagram showing a configuration of a volume management table in the management computer according to the second embodiment.

FIG. 31 is a diagram showing an exemplary logical configuration of a computer system of the second embodiment.

FIG. 32 is a flowchart for explaining a process (overview of the whole process) to distribute load on the storage device according to the second embodiment.

FIG. 33 is a flowchart for explaining the details of the process to determine volume allocation in the second embodiment.

FIG. 34 is a diagram showing an exemplary configuration of a host computer management table in a host computer according to a third embodiment.

FIG. 35 is a diagram showing an exemplary logical configuration in a computer system of the third embodiment.

FIG. 36 is a flowchart for explaining the process (overview of the whole process) to distribute load on the host computer according to the third embodiment.

FIG. 37 is a flowchart for explaining the details of the process to plan, virtual machine allocation and cluster configuration according to the third embodiment.

FIG. 38 is a diagram showing a configuration of a virtual machine management table in the management computer according to a fourth embodiment.

FIG. 39 is a diagram showing an exemplary logical configuration in the computer system of the fourth embodiment.

FIG. 40 is a flowchart for explaining a process (overview of the whole process) on a fault of the storage device according to the fourth embodiment.

FIG. 41A is a diagram showing state transitions in a case where an access is basically made to a primary volume of a copy pair of volumes in the storage devices.

FIG. 41B is a diagram showing state transitions in a case where an access is allowed to either volume of a copy pair of volumes in the storage device.

### DESCRIPTION OF EMBODIMENTS

Hereafter, embodiments of the present invention will be described with reference to accompanying drawings. In the accompanying drawings, functionally identical elements may be represented by the same numbers. Although accompanying drawings show specific embodiments and examples of implementation according to the principle of the present invention, they are for facilitating understanding of the present invention, and never used for limitative interpretation of the present invention.

It should be understood that in the present embodiments, although the explanations are given so adequately and in detail as to enable a person having ordinary skill in the art to practice the present invention, other implementations or embodiments are possible, and change of constitutions and configurations and replacement of various elements are possible without departing from the scope and spirit of the technical thought of the present invention. Further, not all elements or combinations of the elements described therein are always requisite for means for solving problems of the present invention.

Although in the explanations hereafter, information of the present invention is described by expressions including “table aaa,” “list aaa,” etc., such information may be expressed by data structures other than a table, a list, a DB, a cue, etc. Therefore, in order to show the independence from the data structure, “table aaa,” “list aaa,” etc., may be referred to as “aaa information.”

Further, on explaining each kind of information content, expressions including “identification information,” “identifier,” “name,” “title” and “ID” are used. However, these may be exchangeable with each other.

In the explanation hereafter, there are some places where the explanation is given with “program” as a grammatical subject. However, since a program performs predetermined processes by using a memory and a communication port (communication I/F) by being executed by a processor, it is possible to employ an explanation in which the processor is referred to as a grammatical subject. Further, processes disclosed with a program as a grammatical subject may be processes performed by a computer such as a management computer, etc. Further, a part or whole of the program may be implemented by a dedicated hardware.

Hereafter, a set of one or more computers that manage a computer system and that display information to be displayed of the present invention are called as a management system. Where the management computer displays information to be displayed, the management computer is a management system. Further, a combination of a management computer and a computer for displaying is also a management system. Further, in order to achieve acceleration or high reliability it is possible to implement process equivalent to the management computer by a plurality of computers. In that case, the plurality of computers (including a computer for displaying where the computer for displaying performs displaying) are the management system.

### (1) First Embodiment

### <Overall Configuration of the System>

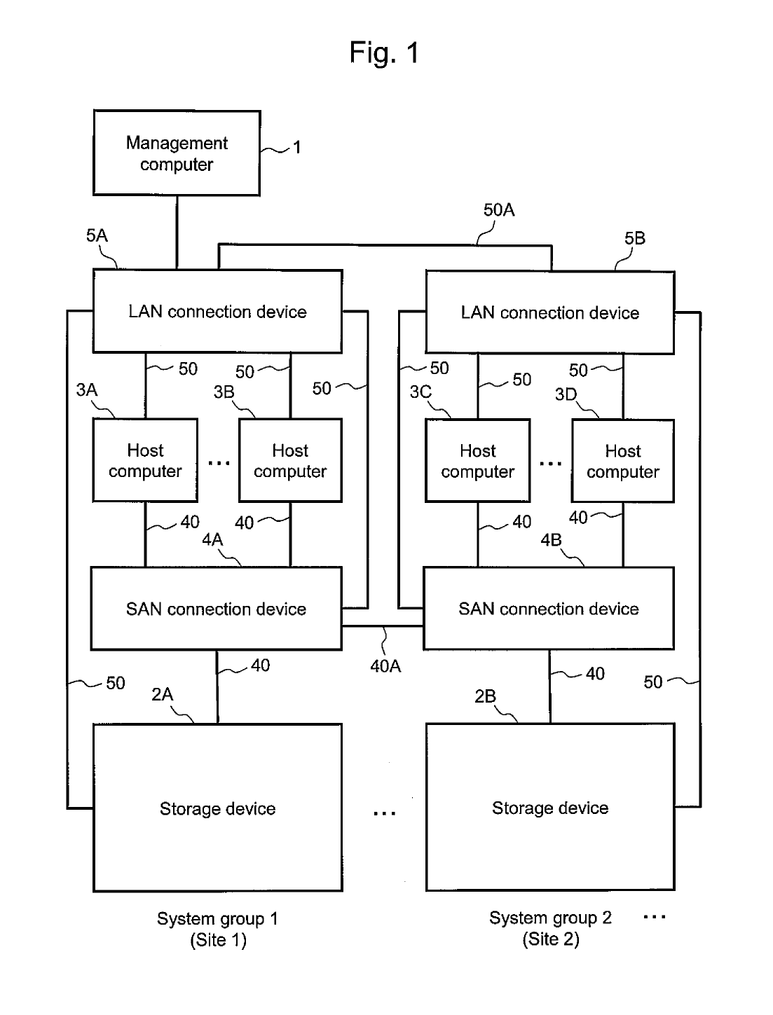

FIG. 1 is a diagram showing an exemplary overall configuration of the whole of the computer system according to first embodiment of the present invention.

As shown in FIG. 1, the computer system comprises a management computer 1, a plurality of storage devices 2A and 2B, a plurality of host computers 3A to 3D, a SAN connection device 4 and a LAN connection device 5.

The connection device in the computer system is a switch that analyzes data received at an input port, selects an output port for transmitting the data, and transmits received data from the output port. The SAN connection device 4 is, for example, a fibre channel switch, and the LAN connection device 5 is, for example, an Ethernet (registered trademark) switch.

Each of the management computer 1, the storage devices 2A and 2B, the host computers 3A to 3D, the SAN connection device 4, and the LAN connection device 5 comprises one or more LAN communications ports. A port of each device (including the management computer 1, the storage device 2 and the host computer 3) is connected to a port of another device (opposed port). The opposed port is, in general, connected via a cable.

The storage device 2 and the host computer 3 comprise one or more SAN communications ports, and a port of each device (including the storage device 2 and the host computer 3) is connected to a port of another device (opposed port). The connection to the opposed port is implemented by, in general, a cable.

The SAN connection device 4 and the LAN connection device 5 are provided by a physically same connection device, and may be a logically independent network. Further, a network constructed by the SAN connection device 4 may be an IP network configured by an Internet Small Computer System Interface (iSCSI), may be provided by a same device as an IP network provided by the LAN connection device 5, and may be a logically independent network. Here, these networks are referred to as a narrow area network or narrow area communications network.

Here, the host computers 3A and 3B are configured to connect to the storage device 2A via a SAN connection device 4A, and configured to be able to communicate with each other by a LAN connection device 5A. Further, the host computers 3C and 3D are configured to connect to the storage device 2B via a SAN connection device 4B and configured to be able to communicate with each other via a LAN connection device 5B. In this time, when the location where the host computers 3A, 3B, the storage device 2A, and the SAN connection device 4A and the LAN connection device 5A connected thereto are installed and the location where the host computers 3C, 3D and the storage device 2B, the SAN connection device 4B and the LAN connection device 5B connected thereto are installed are distant from one another, a SAN connecting line 40A (a wide area network, such as, the Internet), a LAN connecting line 50A (a wide area network, such as, the Internet) that connect respective places with each other may have a narrow band in comparison with the SAN connecting line 40, the LAN connecting line 50 connected in respective places. An extender device may intervene therebetween to connect to a remote location.

The system units of the LAN connection device, the host computer, the SAN connection device and the storage device separated by the wide area network (wide area net) 40A and 50A, may be installed in remote, different places (in that case they may be referred to as site 1 and site 2). Or, respective system units may be installed in the same or different location (same or different site) and managed as different groups (for example, system group 1 and system group 2). Normally, the management computer 1 can acquire configuration information from each device to grasp the topology of the entire computer system, and grasp system groups (sites) constituting the entire computer system. Further, here, connection within the same system group is achieved through a narrow area network such as, SAN and LAN, and connection between the system groups is achieved through a wide area network. However, not limited to this, a communications network between different system groups can be defined as a network having a band narrower than the communications network in the same system group.

### <Configuration of the Management Computer>

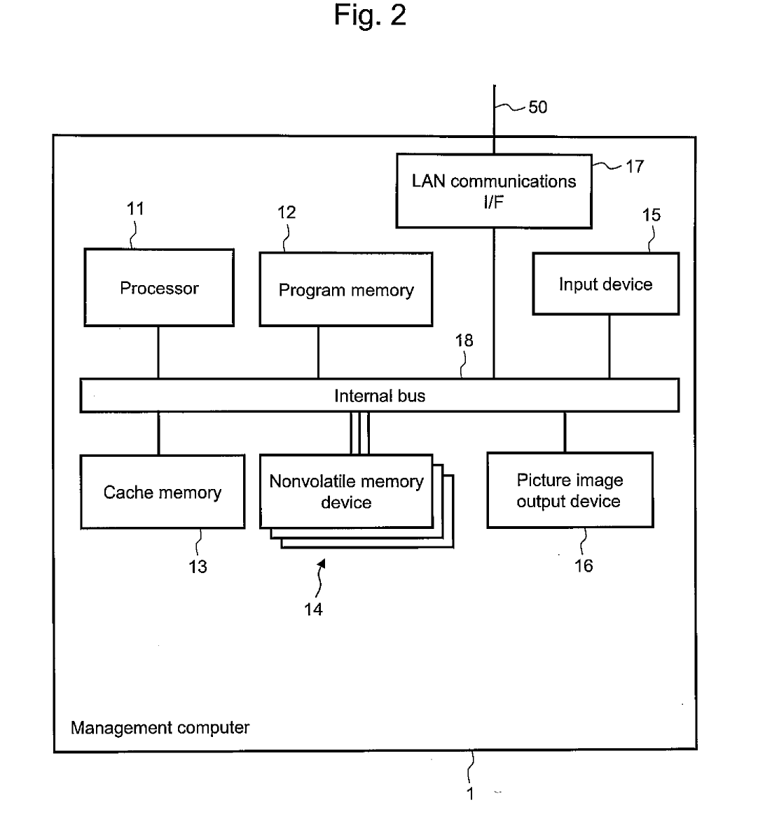

FIG. 2 is a diagram showing an exemplary hardware configuration of the management computer 1.

The management computer 1 comprises a processor 11, a program memory 12, a cache memory 13, a nonvolatile memory device 14, an input device 15, a picture image output device 16, a LAN communications I/F 17, and an internal bus 18. The nonvolatile memory device 14 may be an external memory device connected via a network.

The management computer 1 loads software, such as, an application program or an OS stored in the nonvolatile memory device 14 on the program memory 12 to attain a predetermined function by reading from the program memory 12 and executing it by the processor 11. The processor 11 can include a plurality of chips and a plurality of packages.

The management computer 1 temporarily stores frequently used data in the cache memory 13 and accelerates the process. The management computer 1 comprises an input device 15, such as, a keyboard and a mouse and a picture image output device 16, such as, a display unit. The input device 15 accepts an input from an administrator (user), and the picture image output device 16 outputs information instructed by the processor 11. The management computer 1 further comprises a LAN communications I/F 17 for connecting with the LAN connection device 5.

In the exemplary configuration of FIG. 1, a management system is constituted by the management computer 1. However, the management system may be constituted by a plurality of computers. One of the plurality of computers may be a computer for displaying, and in order to achieve acceleration or high reliability management, a plurality of computers may execute processes equivalent to the management computer, and the management system can include a part of functions of the storage system or connection devices.

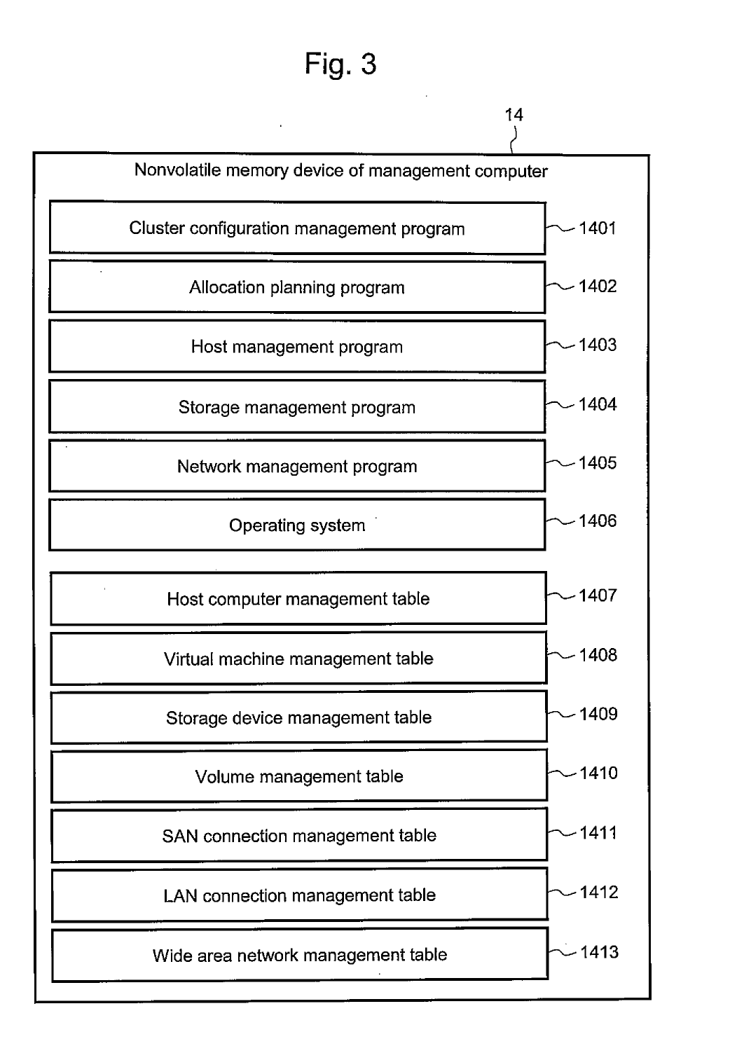

FIG. 3 is a diagram showing information stored in the nonvolatile memory device 14 of the management computer 1 (software configuration).

A cluster configuration management program 1401 communicates with the storage device 2 and the host computer 3 (hypervisor) in the computer system via the LAN connection device 5, and performs reference to cluster configuration and setting of configuration information against a hypervisor, etc. In the embodiments of the present invention a cluster means a range in which a virtual machine can be transferred at an appropriate timing (a group of a host computer).

An allocation planning program 1402 is a program that references to a host computer management table 1407, a virtual machine management table 1408, a storage device management table 1409, a volume management table 1410, a LAN connection management table 1411, a SAN connection management table 1412, a wide area network management table 1413, etc., retained in the management computer, and plans the allocation of the virtual machine and the volume.

A host management program 1403 is a program that communicates with the host computer 3 in the computer system via the LAN connection device 5, references to a state of the host or the virtual machine operating thereon, performs setting of configuration information. Further, the host management program is a program that acquires performance information from each device.

A storage management program 1404 is a program that communicates with the storage device 2 in the computer system via the LAN connection device 5, references to the state of the storage device or the volume stored therein, and performs setting of configuration information.

A network management program 1405 is a program that communicates with the SAN connection device 4 and the LAN connection device 5 in the computer system via the LAN connection device 5, references to SAN connection state, LAN connection state, and the state of wide area network and performs setting of the configuration information.

An operating system 1406 is the foundation of execution of various programs, and the foundation of management of various tables.

Besides the above, the nonvolatile memory device 14 stores a host computer management table 1407, a virtual machine management table 1408, a storage device management table 1409, a volume management table 1410, a LAN connection device management table 1411, a SAN connection device management table 1412 and a wide area network management table 1413. The details for the contents of the various tables will be described below with reference to the drawings.

### <Configuration of Storage Device>

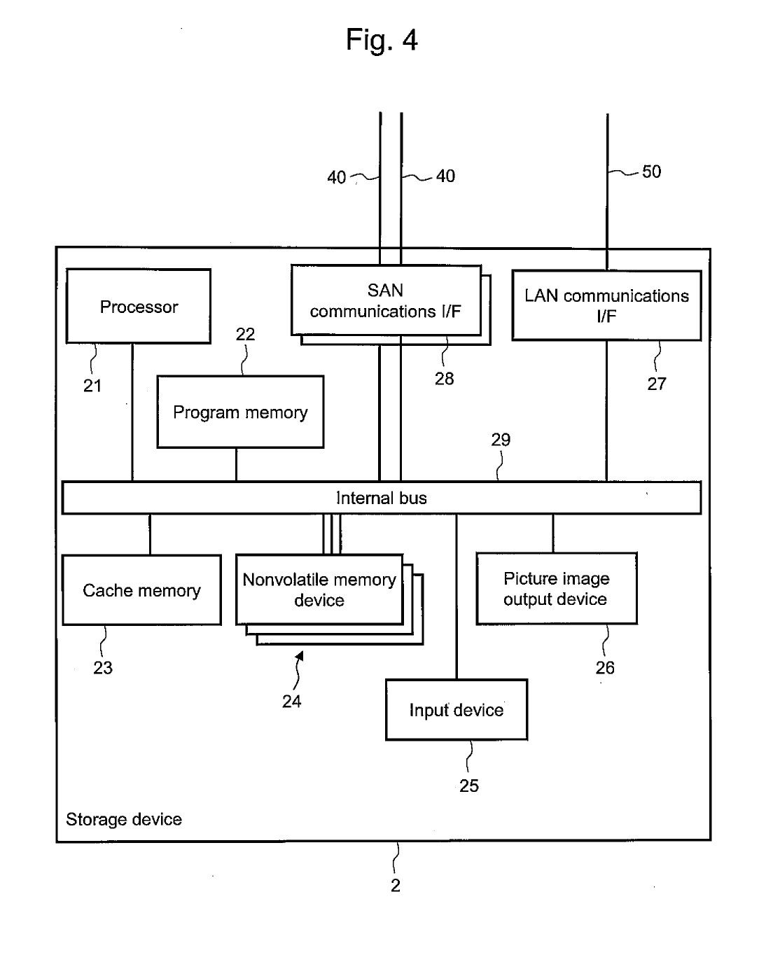

FIG. 4 is a diagram showing an exemplary hardware configuration of the storage device 2.

The storage device 2 comprises a processor 21, a program memory 22, a cache memory 23, a nonvolatile memory device 24, a picture image output device 26, a LAN communications I/F 27, a SAN communications I/F 28 and an internal bus 29.

The storage device 2 loads software, such as, an OS or a control program stored in the nonvolatile memory device 24 on the program memory 22, and the processor 21 reads it from the program memory 22 and executes it to attain a predetermined function. The processor 21 can include a plurality of chips and a plurality of packages.

The non-volatile the storage device 24 includes a plurality of storage drives. The storage drives include a hard disk drive (HDD) comprising a nonvolatile magnetic disk, a Solid State Drive (SSD) having mounted thereon a nonvolatile semiconductor memory (for example flash memory). The storage drive stores data sent from the host computer 3. By providing data with redundancy by a RAID operation by a plurality of storage drives, it is possible to prevent data missing where a fault occurs in one storage drive.

The storage device 2 temporarily stores frequently used data in the cache memory 23 to accelerate the process. The storage device 2 comprises an input device 25, such as, a keyboard and a mouse, a picture image output device 26, such as, a display unit. The input device 25 accepts inputs from an administrator (user), and the picture image output device 26 outputs information instructed by the processor 21. The storage device 2 further comprises a SAN communications I/F 28 for connecting to the SAN connection device 4 and a LAN communications I/F 27 for connecting to the LAN connection device 5.

Although FIG. 1 only shows two storage devices 2 for simplicity, the computer system may comprise three or more storage devices 2.

To the SAN communications I/F 28, a port ID unique in the computer system is allocated, and it is possible to allocate a plurality of virtual port IDs by N_Port ID Virtualization (NPIV) or other virtualization mechanisms.

The SAN communications I/F 28 of the storage device 2 supports both of a target mode that accepts a request of reading and writing from the host computer 3 and an initiator mode that requests reading and writing in another storage device 2. Although the storage device 2 may comprise physically different SAN communications I/Fs 28 for respective modes, a physically single I/F may satisfy both functions logically.

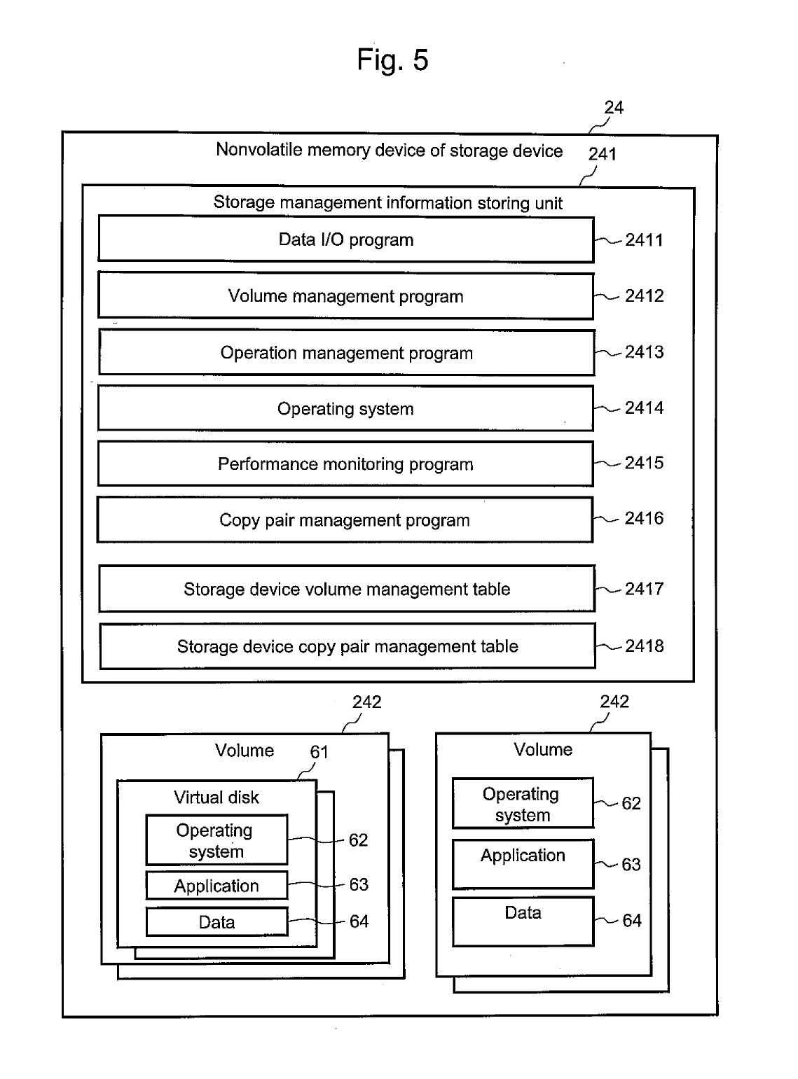

FIG. 5 is a diagram showing information (software configuration) stored in the nonvolatile memory device 24 of the storage device 2.

The nonvolatile memory device 24 stores a storage management information storing unit 241 that stores management information of the storage device 2, at least one volume 242 in which data corresponding to a request of reading and writing from the host computer 3.

A Data I/O program 2411 is a program that receives a request of reading and writing issued from each host computer 3 in the computer system from the SAN communications I/F 28, performs reading and writing of an appropriate volume 242, and returns a response via the SAN communications I/F 28.

A volume management program 2412 is a program that manages the volume 242 in the storage device 2, performs referencing to the volume state and setting of configuration information. The volume management program 2412 manages, for example, preparation of a volume and to which degree the capacity of each volume is used.

An operation management program 2413 is a program that executes an operation management of the storage device 2, and performs a process corresponding to an instruction by the administrator input by the input device 25, and outputs it to the picture image output device. Further, the operation management program 2413 executes a process corresponding to a requested instruction by the management computer 1 or the like via the LAN communications I/F 27, returns a response via the LAN communications I/F 27.

An operating system 2414 is a foundation of executing various programs, and a foundation of management of various tables.

A performance monitoring program 2415 is a program for monitoring and collecting performance information in the storage device 2 (for example, the amount of IO, etc.).

A copy pair management program 2416 is a program for performing a process of copying data written by data I/O program 2411 against a volume (P_Vol) 242 in accordance with information of a copy pair management table 2418 in the storage device 2 and writing the copied data in a volume (S_Vol) 242 to be paired therewith. The pair of the volumes may be made within the storage device. Or, the pair may be made with the volume 242 stored in another storage device 2 via the SAN connection device 4. Copying of the data is performed at an appropriate (arbitrary) timing. For example, after writing in a volume in synchronization with writing in a volume to be paired therewith, a write completion response against a volume may be returned. Further, for example, an asynchronous scheme in which after returning a response against writing in a volume, writing may be performed in a volume to be paired therewith. Further, for example, a scheme may be employed in which data consistency is secured by limiting a domain in which writing is performed, or by utilizing an electric time stamp of a write command, in a system in which, in a circumstance where both of the volumes to be paired are stored in different storage devices, writing is performed from both the storage devices to their respective volumes to be paired. Further, the copy pair management program 2416 monitors the states of the volumes to be paired, and performs a process of changing the state of the copy pair on detection of a fault, and when the fault is rectified, again implements data copying so that data protection corresponding to writing can be achieved to change the state of the copy pair to the paired state. Further, the copy pair management program 2416 performs control, such as, prohibiting writing in a copy source volume where writing in the copy destination volume is detected to retain consistency of the replication of data writing of the copy pair by the unit of volume. Further, in order to manage which of the copy pairs is normally operating when a fault has occurred in the storage device 2, a scheme may be adopted in which consistency is maintained by disposing a Quorum disk in yet another storage device other than the storage device 2 storing the volume for which the copy pair is made.

The nonvolatile memory device 24, in addition to the above, stores a storage device volume management table 2417 and a storage device copy pair management table 2418. The details of each table will be stated below with reference to the drawings.

The volume 242 stores, for example, a virtual disk 61 utilized by a virtual machine 7, an operating system 62 utilized by the host computer 3, an application 63, data 64 or the like. Also, the virtual disk 61 stores an operating system 62, an application 63, data 64 or the like.

### <Configuration of Host Computer>

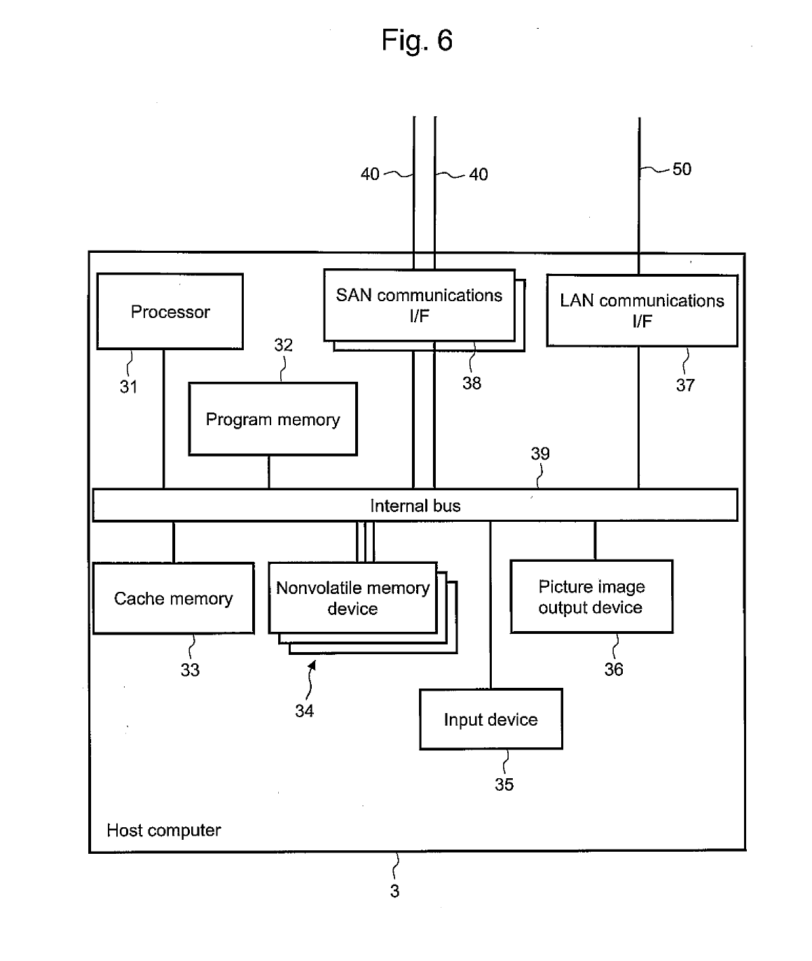

FIG. 6 is a diagram showing an exemplary hardware configuration of the host computer 3.

The host computer 3 comprises a processor 31, a program memory 32, a cache memory 33, a nonvolatile memory device 34, an input device 35, a picture image output device 36, a LAN communications I/F 37 and an internal bus 38. The nonvolatile memory device 34 may be an external memory device connected via a network.

The host computer 3 loads software, such as, an OS or an application program stored in the nonvolatile memory device 34 on the program memory 32, and the processor 31 reads it from the program memory 32 and executes it to attain the predetermined function. Further, as the processor 31, a configuration including a plurality of chips and a plurality of packages.

The host computer 3 temporarily stores frequently used data in the cache memory 33 to accelerate the process. Further, the host computer 3 comprises an input device 35, such as, a keyboard and a mouse, and a picture image output device 36, such as, a display unit. The input device 35 accepts inputs from the administrator (user), and the picture image output device 36 outputs information instructed by the processor 31. Further, the host computer 3 comprises a SAN communications I/F 38 for connecting to the SAN connection device 4 and a LAN communications I/F 37 for connecting to the LAN connection device.

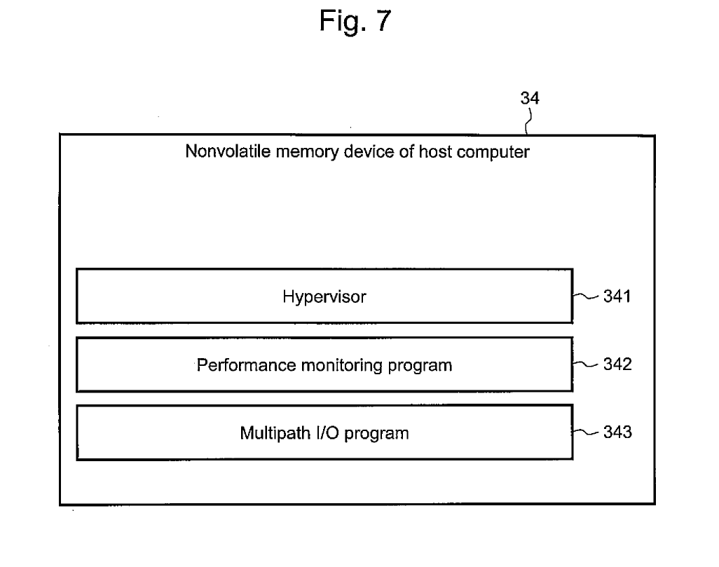

FIG. 7 is a diagram showing information stored by the nonvolatile memory device 34 of the host computer 3 (software configuration).

A hypervisor 341 is a foundation of executing a virtual machine. A performance monitoring program 342 is a program that monitors processing load on the host computer 3 or the processing load of the virtual machine, and can respond when an acquisition request has come from the management computer 1 or the like via the LAN communications I/F 37.

A multipath I/O program 343 is a program that recognizes the volume 242 of the storage device 2 detected via a plurality of SAN communications I/Fs as a same volume with reference to the volume identifier, sends a request of reading and writing of the volume in a dispersed manner to the plurality of SAN communications I/Fs and receives a response. In this process, in a system in which the volumes stored in the plurality of the storage devices 2 are synchronized at appropriate (arbitrary) timing, where different volume identifiers are responded, setting may be such that they are recognized as a same volume as the multipath I/O program and operated.

### <Configuration of SAN Connection Device>

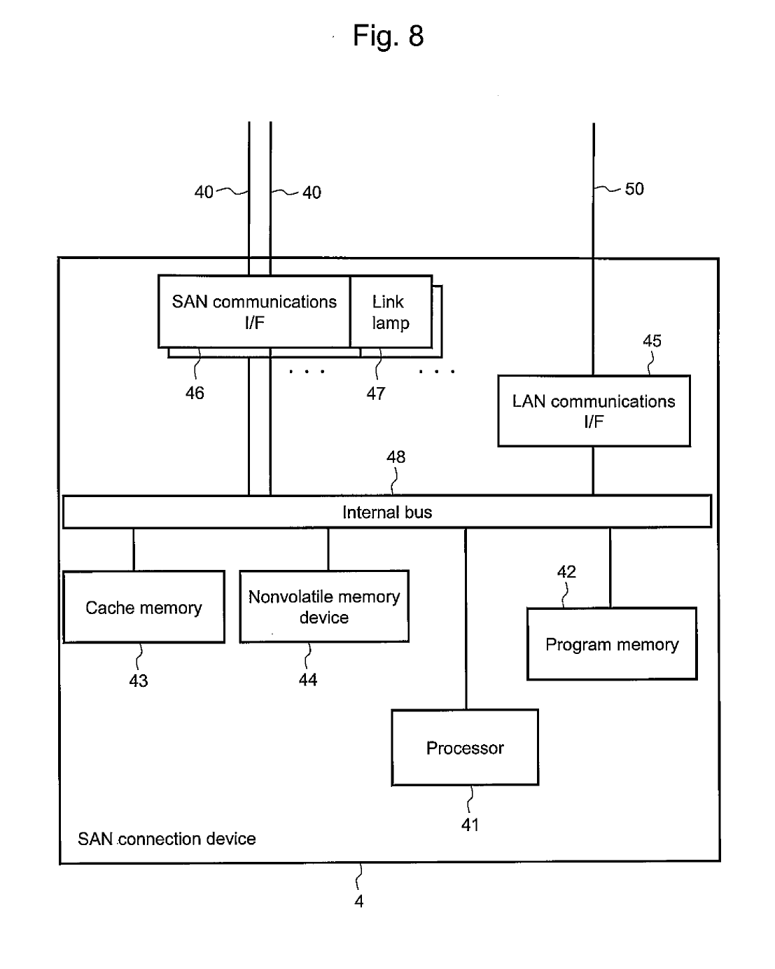

FIG. 8 is a diagram showing an exemplary hardware configuration of the SAN connection device 4.

The SAN connection device 4 comprises a processor 41, a program memory 42, a cache memory 43, a nonvolatile memory device 44, a LAN communications I/F 45, a SAN communications I/F 46, a link lamp 47 and an internal bus 48.

The SAN connection device 4 loads software, such as, an OS or a program stored in the nonvolatile memory device 44 on the program memory 42, and the processor 41 reads it from the program memory 42 and executes it to attain a predetermined function.

Further, the SAN connection device 4 stores frequently used data in the cache memory 43 to accelerate a process. The SAN connection device 4 comprises the link lamp 47 comprising an LED or other light emitting devices, and can visualize logical connection state of the SAN communications I/F 46.

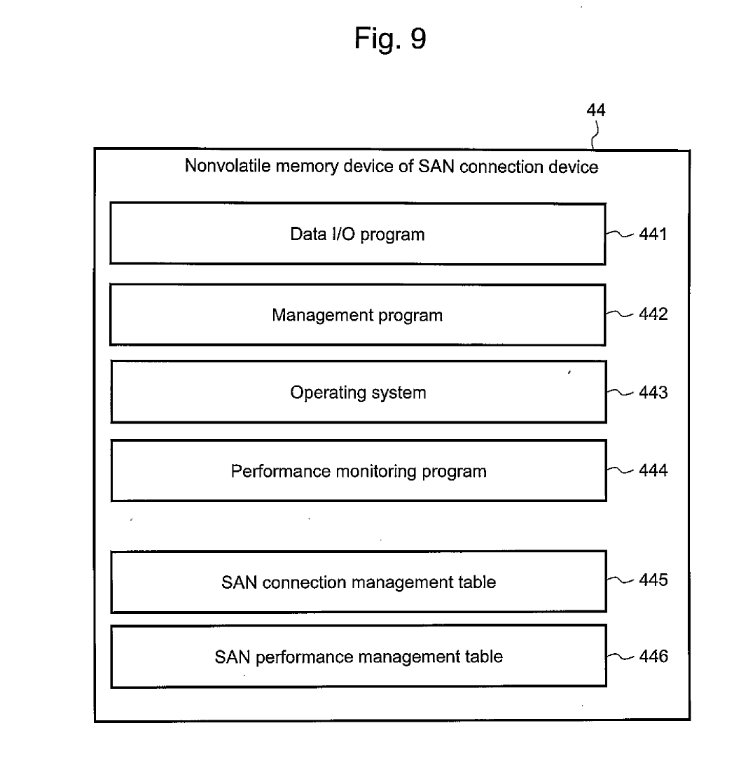

FIG. 9 is a diagram showing an example of information stored in the nonvolatile memory device 44 of the SAN connection device 4 (software configuration).

The nonvolatile memory device 44 of the SAN connection device 4 stores a data I/O program 441 that transfers a request of reading and writing issued from the host computer 3 or the like received in the SAN communications I/F 46, to an appropriate SAN communications I/F 46, a management program 442 that performs management of the SAN connection device, an operating system 443 that is a foundation of management of various tables and the foundation of executing various programs, a performance monitoring program 444 that monitors and collects performance information of the SAN connection device, a SAN connection management table 445, and a SAN performance management table 446.

### <Configuration of LAN Connection Device>

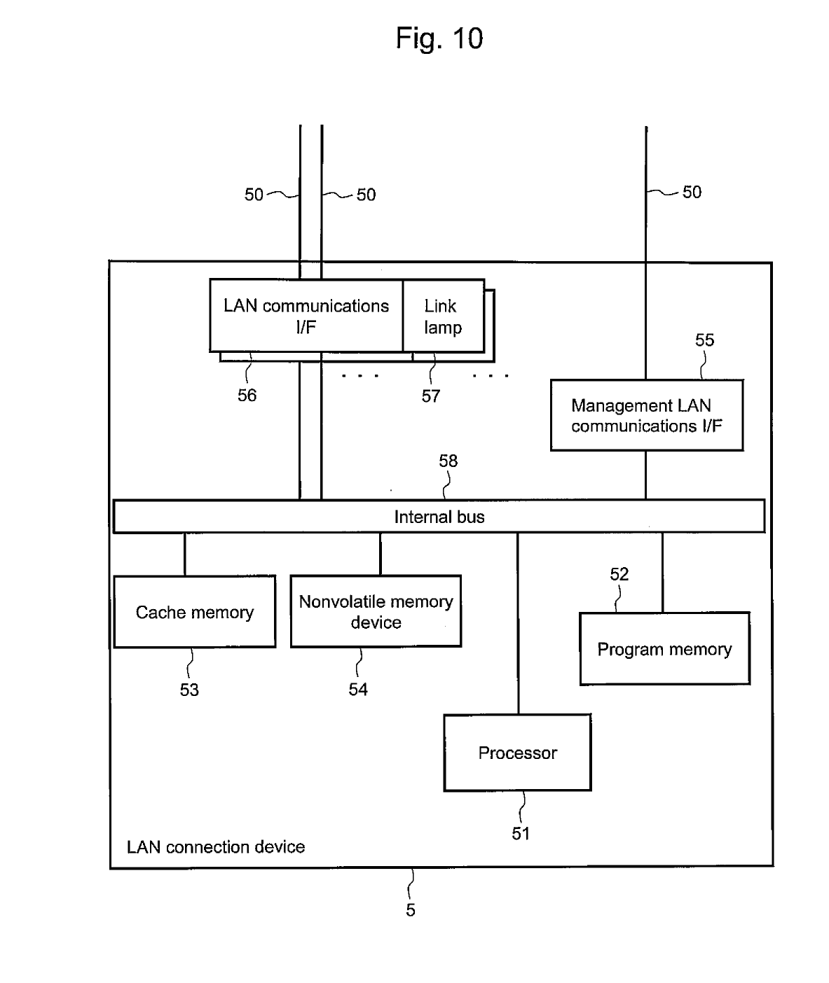

FIG. 10 is a diagram showing an exemplary hardware configuration of the LAN connection device 5.

The LAN connection device 5 comprises a processor 51, a program memory 52, a cache memory 53, a nonvolatile memory device 54, a management LAN communications I/F 55, a LAN communications I/F 56, a link lamp 57 and an internal bus 58.

The LAN connection device 5 loads software, such as, an OS or a program stored in the nonvolatile memory device 54 on the program memory 52, and the processor 51 reads it from the program memory 52 and executes it to attain a predetermined function.

Further, the LAN connection device 5 stores frequently used data in the cache memory 53 to accelerate processes. The LAN connection device 5 comprises the link lamp 57 comprising an LED and other light emitting devices, to visualize logical connection state of the LAN communications I/F 56.

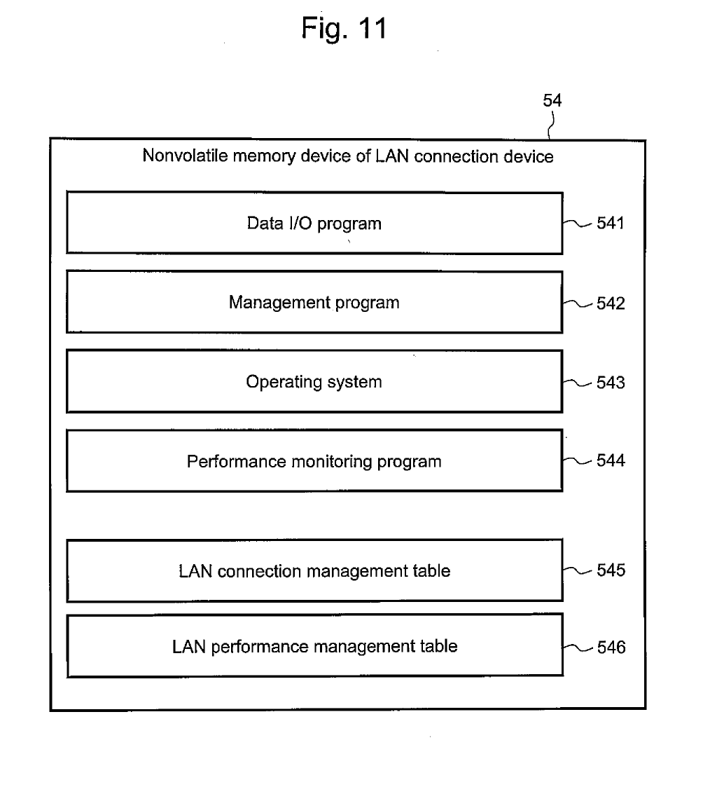

FIG. 11 is a diagram showing an example of information stored in the nonvolatile memory device 54 of the LAN connection device 5 (software configuration).

The nonvolatile memory device 54 of the LAN connection device 5 stores a data I/O program 541 that transfers a communication request issued from the host computer 3 or the like and received at the LAN communications I/F 56 to appropriate LAN communications I/F 56, a management program 542 that performs management of the LAN connection device, an operating system 543 that is the foundation of execution of various programs, and a foundation of management of various tables, a performance monitoring program 544 that monitors and collects performance information of the LAN connection device, a LAN connection management table 545 and a LAN performance management table 546.

### <Host Computer Management Table>

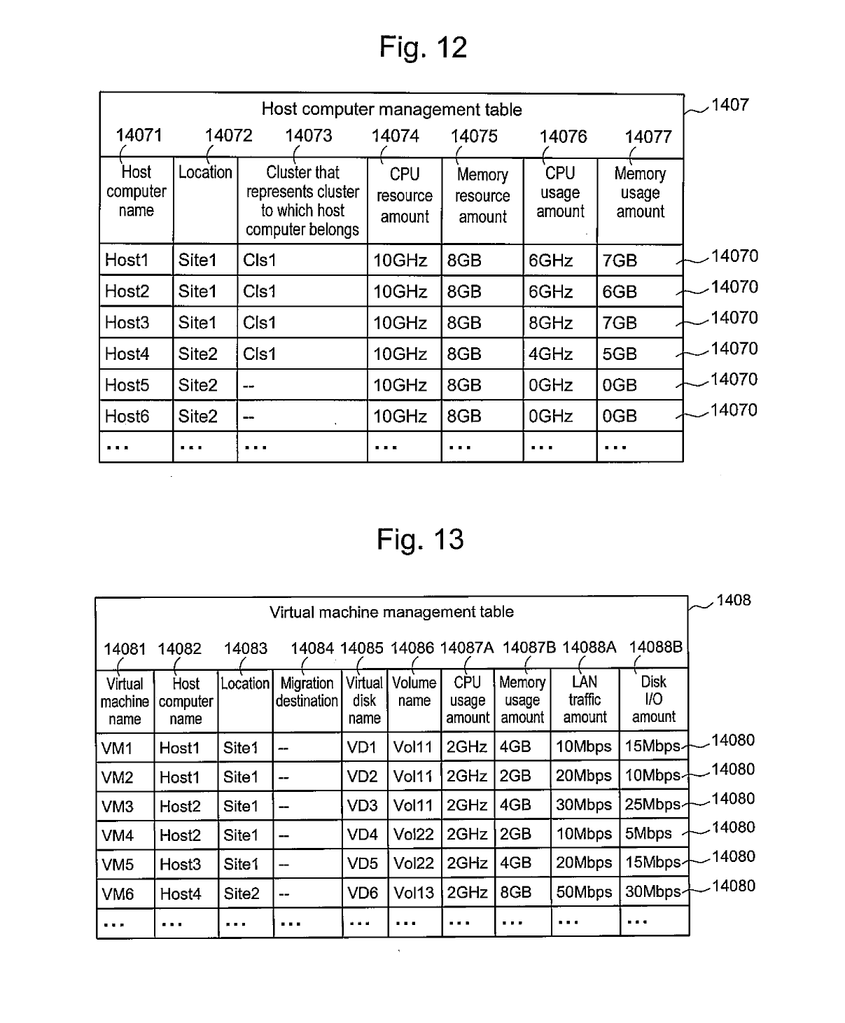

FIG. 12 is a diagram showing one exemplary configuration of the host computer management table 1407 in the management computer 1 of the first embodiment.

The host computer management table 1407 comprises an entry 14070 for each host computer, and comprises, for each entry 14070, a host computer name 14071 that is an identifier of the host computer, a location 14072 that represents a location (system group) where there is the host computer, a cluster 14073 that represents a cluster to which the host computer belongs, a CPU resource amount 14074 that represents the amount of CPU resources of the host computer, for example, a product of an operation frequency of the CPU and the CPU core, an amount of memory resource 14075 that represents the total memory amount of the host computer, a CPU usage amount 14076 that represents the CPU resource having allocated to the virtual machine of the amount of CPU resource, an amount of memory usage 14077 that represents memory resource having allocated to the virtual machine of the amount of memory resource, as constituent items. Here, it is assumed that resource amount having allocated is the used amount. Further, as described above, a cluster means a range in which the virtual machine can be transferred at an appropriate timing. Therefore, in a same cluster, the configuration of the virtual machine can be freely transferred.

### <Virtual Machine Management Table>

FIG. 13 is a diagram showing one exemplary configuration of the virtual machine management table 1408 in the management computer of the first embodiment.

The virtual machine management table 1408 comprises an entry 14080 for each virtual machine and comprises, for each entry 14080, a virtual machine name 14081 that is an identifier of the virtual machine, a host computer name 14082 that represents a host computer on which the virtual machine is operating, a location 14083 that represents a location in which the virtual machine is operating, a transfer destination 14084 that stores information of a transfer destination when transferring of the virtual machine is necessary, a virtual disk name 14085 that is an identifier of a virtual disk used by the virtual machine, a volume name 14086 that is an identifier of a volume in which the virtual disk is stored, a CPU usage amount 14087A that represents an amount of CPU resource allocated to the virtual machine, a memory usage amount 14087B that represents an amount of memory resource allocated to the virtual machine, a LAN traffic amount 14088A that represents a network traffic amount issued by the virtual machine, a Disk I/O amount 14088B that represents a disk I/O amount issued by the virtual machine, as constituent items.

Here, the virtual machine may be configured to comprise a plurality of virtual disks 14085, and respective virtual disks 14085 may be stored in different volumes 14086.

In the CPU usage amount 14087A, and the memory usage amount 14087B, an amount of resource allocated on preparation of the virtual machine is stored. These are changed each time the configuration allocated to the virtual machine is changed.

The LAN traffic amount 14088A and the Disk I/O amount 14088B are acquired by querying to the performance monitoring program 342 of the host computer 3 by the host management program 1403 of the management computer 1, for example, at an interval of a predetermined time. An average value of the acquired values may be stored.

### <Storage Device Management Table>

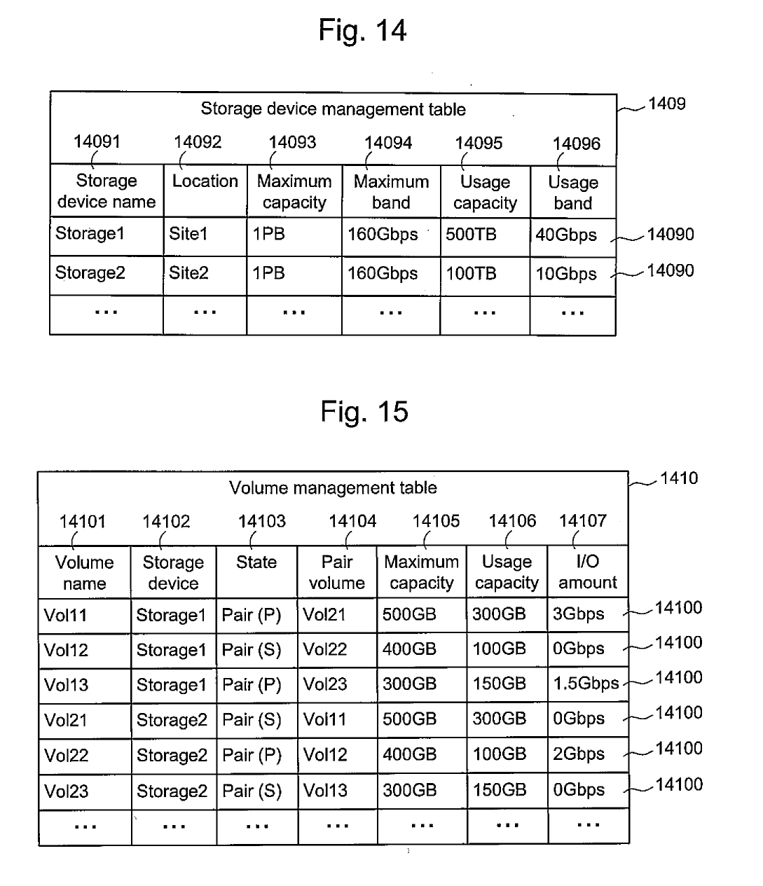

FIG. 14 is a diagram showing one exemplary configuration of the storage device management table 1409 of the management computer 1 in the first embodiment.

The storage device management table 1409 comprises an entry 14090 for each storage device, and includes, for each entry 14090, a storage device name 14091 that is an identifier of the storage device, a location 14092 that represents a location in which the storage device is installed (system group), a maximum capacity 14093 that represents a disk capacity of the entire storage device, a maximum band 14094 that represents a maximum access performance against the entire storage device, a usage capacity 14095 that represents a capacity allocated to a volume stored in the storage device 2, a usage band 14096 that represents a band used by disk access from the host computer 3, as constituent items.

### <Volume Management Table>

FIG. 15 is a diagram showing one exemplary configuration of the volume management table 1410 of the management computer of the first embodiment.

The volume management table 1410 comprises an entry 14100 for each volume of the entire storage device 2 residing in the entire computer system, and comprises, for each entry 14100, a volume name 14101 that is an identifier of the volume, a storage device 14102 that represents a device in which the volume is stored, a state 14103 that represents the state of a copy pair, a pair volume 14104 that represents a companion of the copy pair, a maximum capacity 14105 that represents a maximum capacity of the volume, a usage capacity 14106 that represents the amount of data stored in the volume, an I/O amount 14107 that represents the amount of I/O issued against the volume (instantaneous value or an average value in a predetermined period) as constituent items.

### <SAN Connection Management Table>

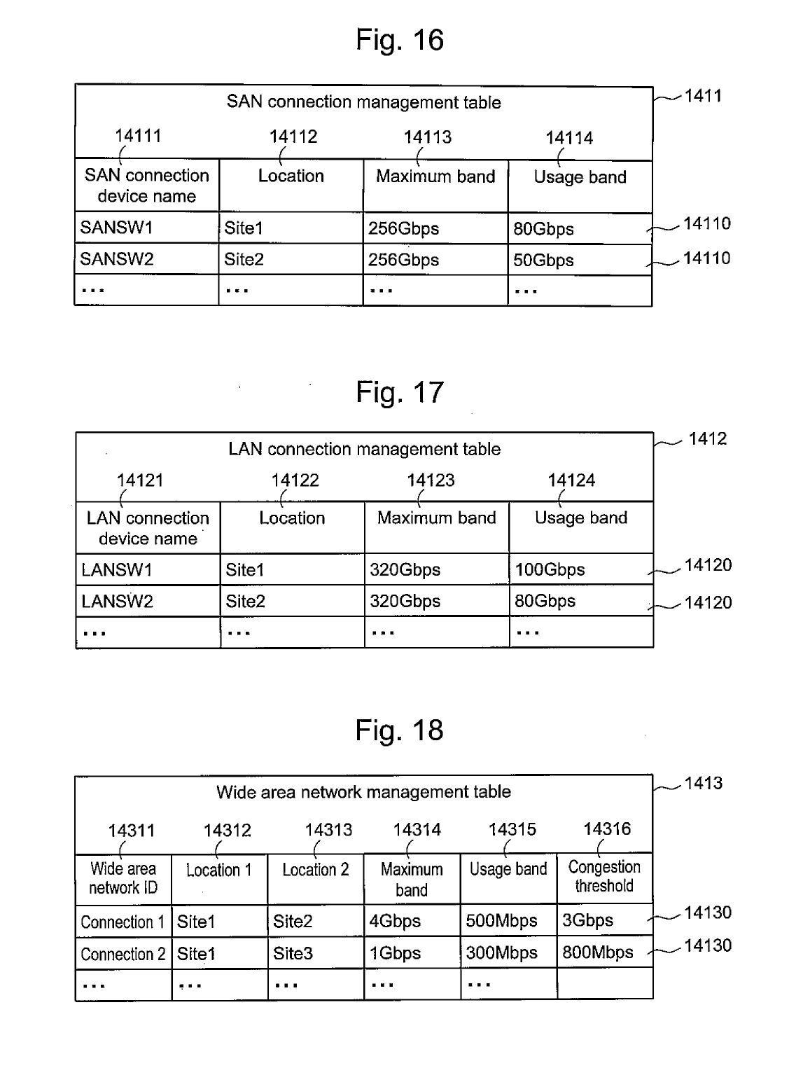

FIG. 16 is a diagram showing one exemplary configuration of the SAN connection management table 1411 of the management computer 1 in the first embodiment.

The SAN connection management table 1411 comprises an entry 14110 for each SAN connection device, and comprises, for each entry, a SAN connection device name 14111 that is an identifier of the SAN connection device, a location 14112 that is a location of installation of the SAN connection device, a maximum band 14113 as an example of the index representing the load over the entire SAN connection device, and a usage band 14114 as an example of the usage rate of the maximum band, as constituent items.

### <LAN Connection Management Table>

FIG. 17 is a diagram showing one exemplary configuration of the LAN connection management table 1412 of the management computer 1 in the first embodiment.

The LAN connection management table 1412 comprises an entry 14120 for each LAN connection device, and comprises, for each entry, a LAN connection device name 14121 that is an identifier of the LAN connection device, 14122 that is a location (system group) of installation of the LAN connection device, a maximum band 14123 as an example of the index representing the load over the entire LAN connection device and a usage band 14124 as an example of the usage rate of the maximum band, as constituent items.

### <Wide Area Network Management Table>

FIG. 18 is a diagram showing one exemplary configuration of the wide area network management table 1413 of the management computer 1 in the first embodiment.

The wide area network management table 1413 comprises an entry 14130 for each wide area network, and comprises, for each entry, a wide area network ID 14311 that is an identifier of the wide area network, a location (that may be a system group) 1_14312, that is an origin of connection of the wide area network, a location 2_14313 that is a terminal node, a maximum band 14314 that is a maximum band of the transfer of the wide area network, a usage band 14315 that is a usage band of the wide area network, a congestion threshold 14136 that is a threshold to detect the congestion of the wide area network, as constituent items.

As for usage band, information may be acquired from the SAN connection device, and the LAN connection device that constitutes the wide area network and updated and stored at an appropriate (arbitrary) timing. Further, other values may be input by an administrator on building the wide area network.

### <Storage Device Volume Management Table>

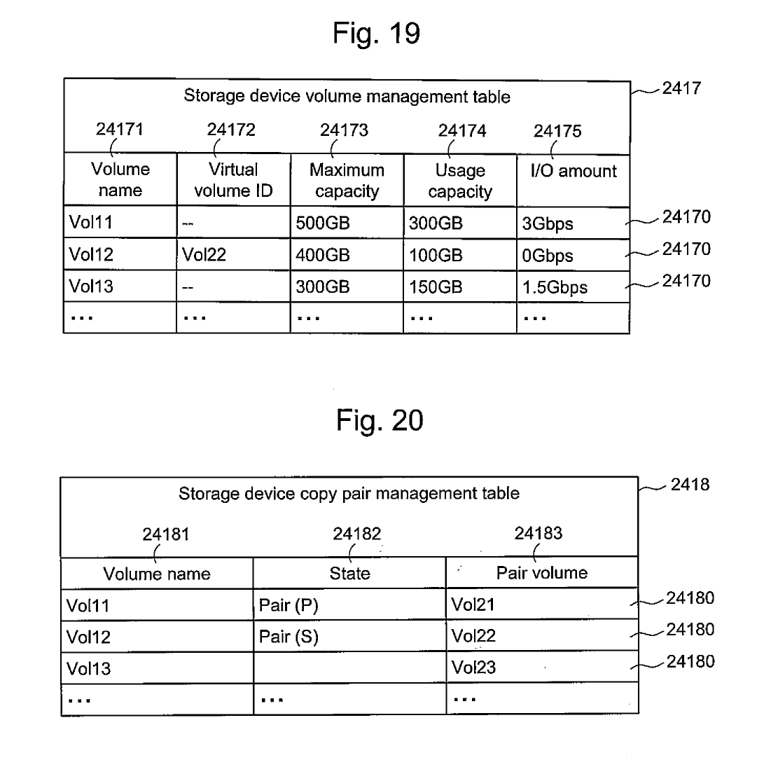

FIG. 19 is a diagram showing one exemplary configuration of the storage device volume management table 2417 in the storage device 2 of the first embodiment.

The storage device volume management table 2417 comprises an entry 24170 for each volume in the storage device and comprises, for each entry, a volume name 24171 that is an identifier of the volume, a virtual volume ID 24172 utilized where there is a necessity to change the identifier for response to the host, a maximum capacity 24173 that shows a maximum capacity of the volume, usage capacity 24174 that represents the amount used by the data stored in the volume, an I/O amount 24175 as one example of the index of performance load against the volume, as constituent items.

### <Storage Device Copy Pair Management Table>

FIG. 20 is a diagram showing one exemplary configuration of the storage device copy pair management table 2418 in the storage device of the first embodiment.

The storage device copy pair management table 2418 comprises, for each volume for which a copy pair is made, an entry 24180, and comprises, for each entry, a volume name 24181, a state 24182 that represents a paired state and a pair volume 24183, as constituent items.

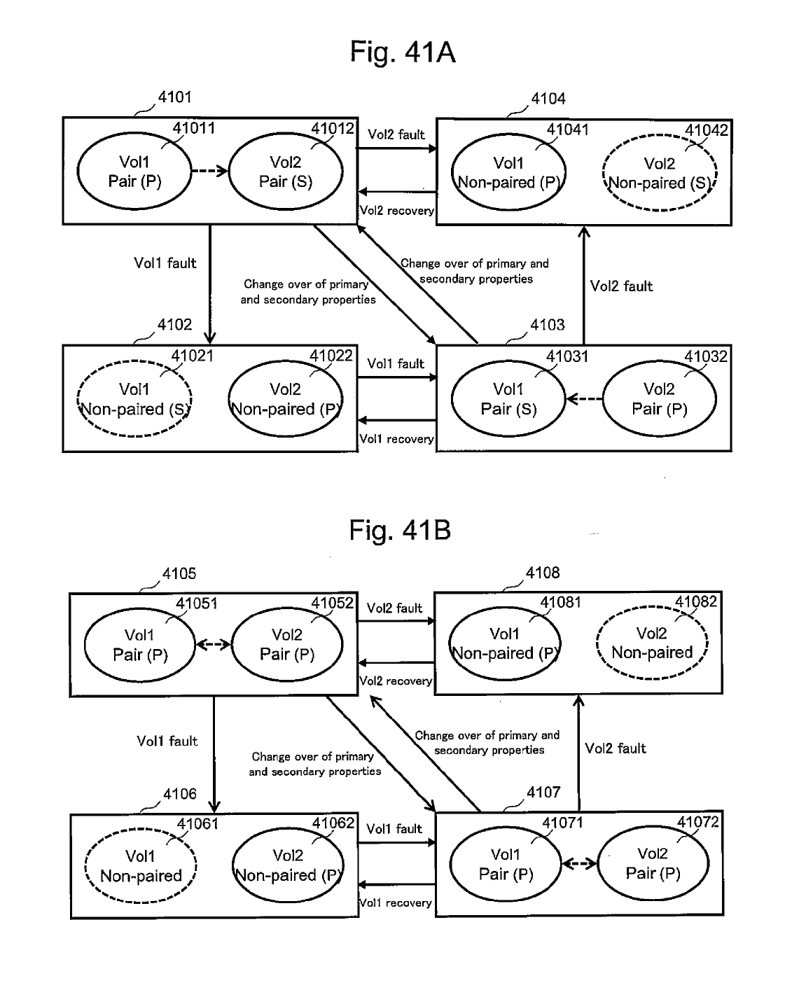

Here, the state 24182 is information that represents a copy state of the two volumes in which information is copied at an appropriate (arbitrary) timing. As shown in FIG. 41A, where copy has appropriately been performed, the state is a paired state, where copy is not executed due to a fault or the like, the state is a state without pair. Further, in the present invention, the state of a volume that accepts I/O from the host computer is (P) state as Primary Volume. On the other hand, the state of a volume that does not accept I/O from the host computer and copy data from the Primary Volume is written is the (S) state as a Secondary Volume. When a fault occurs in the volume of the paired (P) state, the state of the volume in the paired (P) state is a non-paired (S) state, and the state of the volume in which a copy pair with the volume is made is changed from paired (S) to non-paired (P) to accept I/O from the host. However, as shown in FIG. 41B, where both the volumes in which two copy pairs have formed accept I/O from the host, when a copy pair is formed with no fault having occurred, the state of either volume is the paired (P) state, and when no copy pair is being formed, due to a fault or the like, the state is the non-paired state. In this case, when a volume continues to accept the access with no fault having occurred, the state of the volume is the nonpaired (P) state, and when fault has occurred in a volume, the state of the volume is simply the non-paired state.

FIG. 41A shows is a diagram showing state transitions in a case where an access is basically made to a primary volume of a copy pair of volumes in the storage device. State 4101 shows that Vol1_41011 and Vol2_41012 are paired up as a copy pair and the I/O from a host computer is accessed to Vol1_41011 whose state is a paired (P) state. The difference data between written data and the original data is stored into Vol2_41012 whose state is a paired (S) state so that Vol1_41011 and Vol2_41012 are synchronized at an appropriate timing. At this time, if Vol1_41011 becomes a state (4102) in which the volume can not be accessed due to the occurrence of fault in the volume, the copy pair state is canceled so that Vol1 and Vol2 have become non-paired state. In this case, because the access to vol1_41021 is prohibited, Vol2_41022 has become non-paired (P) state to accept and respond to I/Os from host computers. Later, when Vol1_41021 recovers form the fault to become accessible, Vol1_41031 and Vol2_41032 are paired up again by writing data in Vol2_41032 (P) into Vol1_41031 so that a redundant configuration state (4103) can be realized. To change the state from state 4101 to state 4103 by switching over primary (P) and secondary (S) properties of the volumes, may be adopted a method of temporarily cancelling the pair property as in state 4102, and may also be adopted a method of temporarily inhibiting the I/O to Primary volume to changing over the primary and secondary properties of the volume in cooperation with the operation of changing over I/O path from a host computer by controlling the access path from the host computer.

FIG. 41B a diagram showing state transitions in a case where an access is allowed to either volume of a copy pair of volumes in the storage device. At this time, in state 4104, an access can be made to either vol1_41051 or vol2_41052 from a host computer. In this case, a redundant configuration is realized by performing mutual copy operation with storage synchronizing function for guaranteeing data consistency. Other operations in FIG. 41 B are the same as in FIG. 41A.

### <SAN Port Connection Management Table>

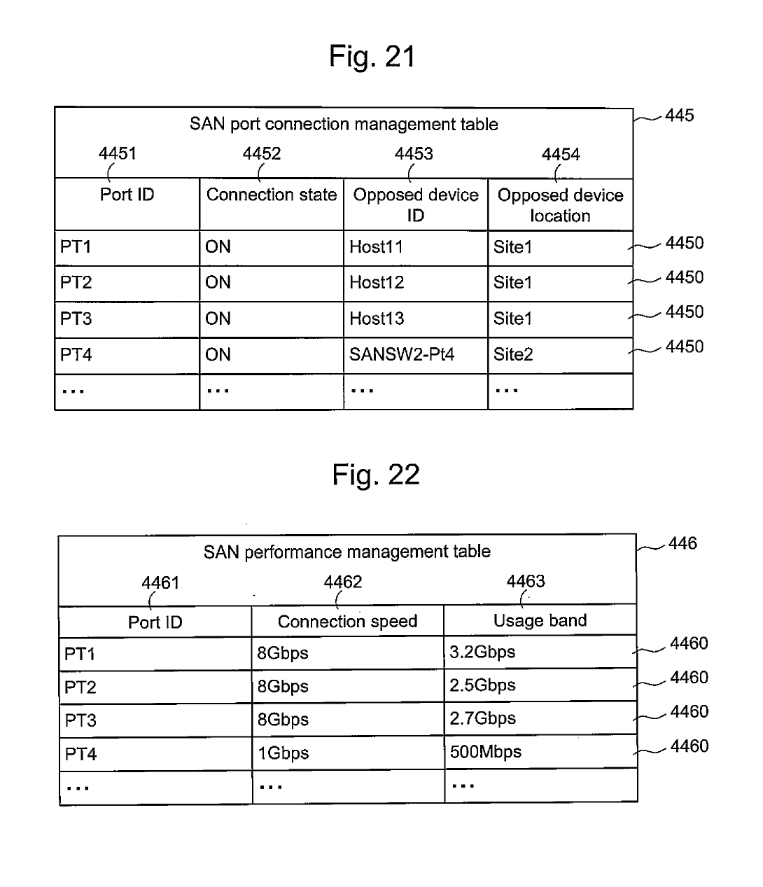

FIG. 21 is a diagram showing one exemplary configuration of the SAN port connection management table 445 of the SAN connection device 4 (4A, 4B, . . . ) in the first embodiment.

The SAN port connection management table 445 comprises an entry 4450 for each physical port, and comprises, for each entry 4450, a port ID 4451 that is an identifier of the physical port, a connection state 4452 that retains a physical connection state, an opposed device ID 4453 that is an identifier of the opposed device, an opposed device location 4454 that represents a location of installation of the opposed device (or, the system group to which the opposed device belongs), as constituent items.

### <SAN Port Performance Management Table>

FIG. 22 is a diagram showing one exemplary configuration of the SAN performance management table 446 of the SAN connection device 4 (4A, 4B, . . . ) of the first embodiment.

The SAN performance management table 446 comprises an entry 4460 for each physical port, and comprises, for each entry 4460, a port ID 4461 that is an identifier of the physical port, a connection speed 4462 established by the physical port in confirmation of connecting to an opposed device, a usage band 4463 experimentally used for communication with the opposed device, as constituent items.

### <LAN Port Connection Management Table>

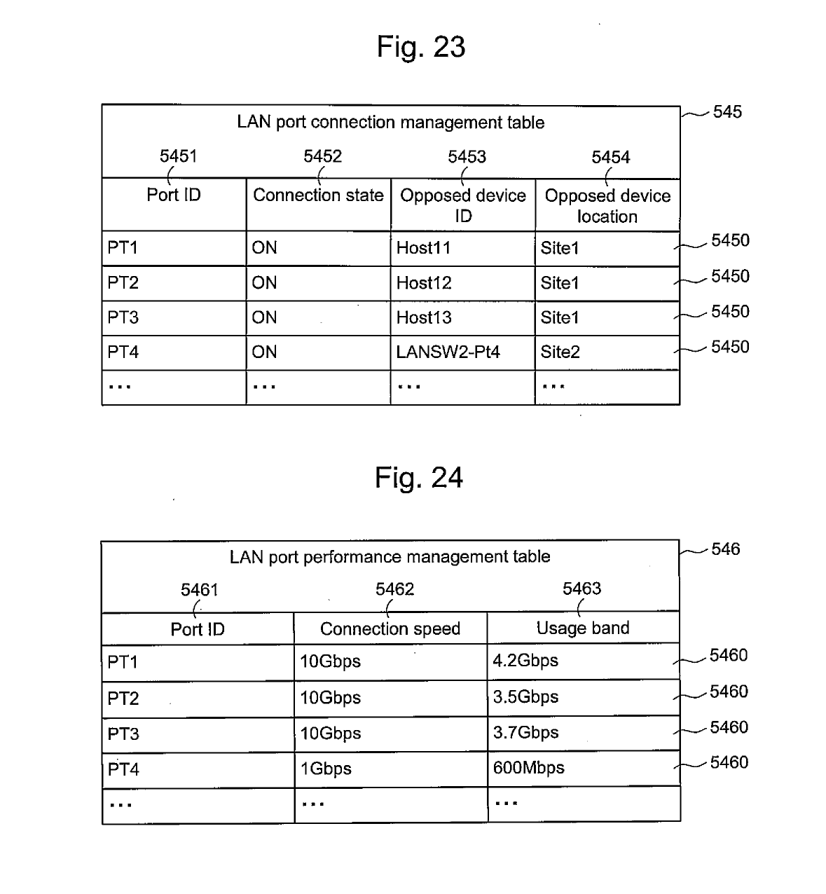

FIG. 23 is a diagram showing one exemplary configuration of the LAN connection management table 545 in the LAN connection device 5(5A, 5B, . . . ) in the first embodiment.

The LAN connection management table 545 comprises an entry 5450 for each physical port, and comprises, for each entry 5450, a port ID 5451 that is an identifier of the physical port, a connection state 5452 that retains a physical connection state, an opposed device ID 5453 that is an identifier of the opposed device, an opposed device location 5454 that represents a location of installation of the opposed device (or, a system group to which the opposed device belongs), as constituent items.

### <LAN Port Performance Management Table>

FIG. 24 is a diagram showing one exemplary configuration of the LAN performance management table 546 of the LAN connection device 5 (5A, 5B, . . . ) in the first embodiment.

The LAN performance management table 546 comprises an entry 5460 for each physical port, and comprises, for each entry 5460, a port ID 5461 that is an identifier of the physical port, a connection speed 5462 established by the physical port in confirmation of connecting to an opposed device, a usage band 5463 experimentally used for communication with the opposed device, as constituent items.

### <Logical Configuration of Computer System>

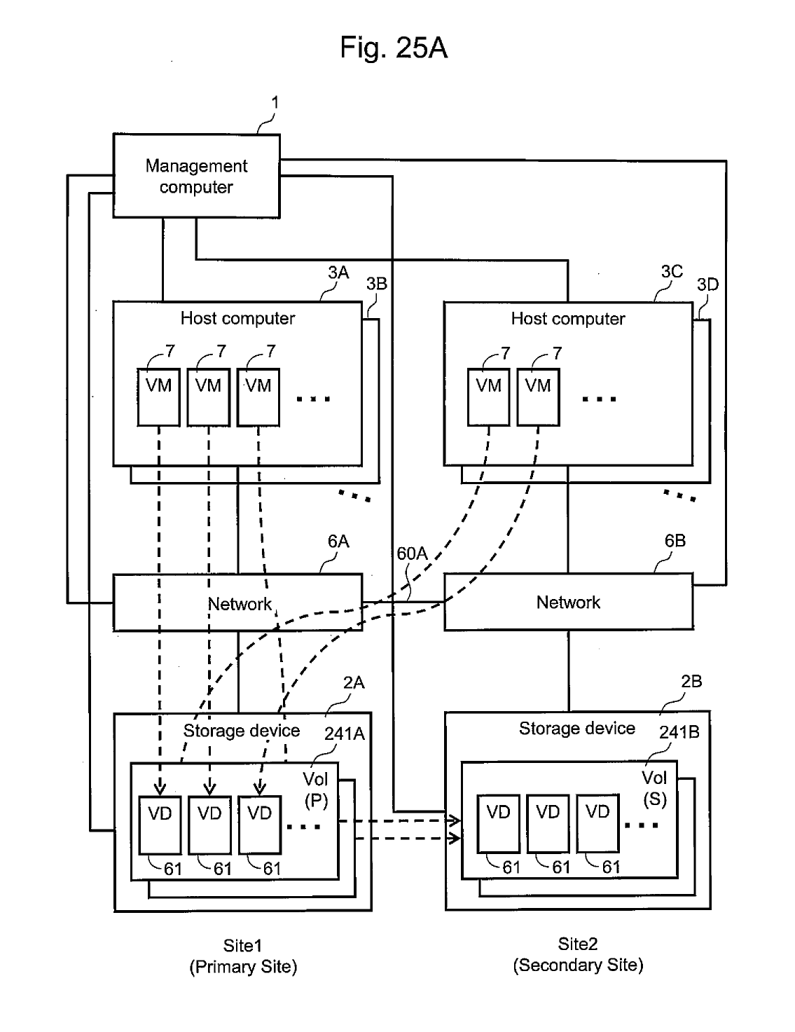

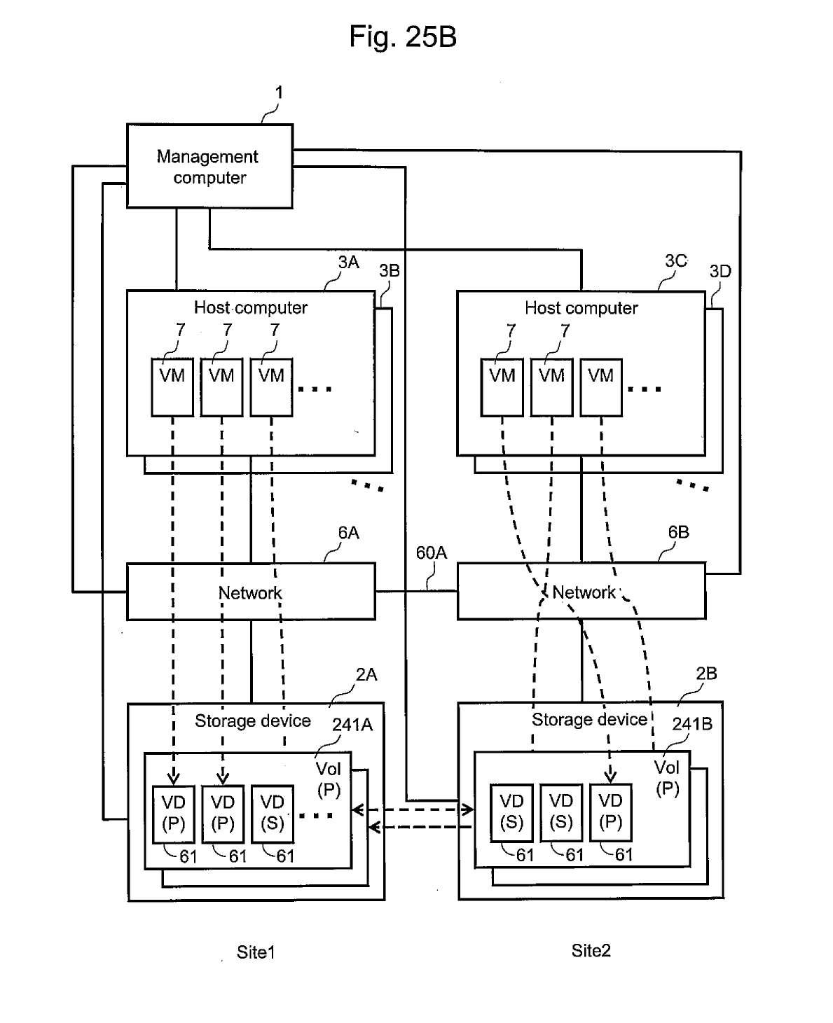

FIG. 25 is a diagram showing an exemplary logical configuration of the computer system in the first embodiment. FIG. 25A is a diagram showing a scheme in which, where all the virtual servers access to the virtual disk (P_Vol) formed on a primary site (site 1/system group 1), and there is a change (writing or deletion) in P_Vol, the change is reflected (synchronized) on the virtual disk (S_Vol) corresponding to a secondary site (site 2/system group 2). FIG. 25B is a diagram showing a scheme in which a virtual server formed on the primary site accesses the virtual disk (P_Vol) formed on the primary site, a virtual server formed on the secondary site accesses the virtual disk (S_Vol) copied on the secondary site. Where there are changes in the respective volumes, the changes are mutually reflected (synchronized).

### (i) FIG. 25A

The management computer 1 connects to the storage device 2, the host computer 3, and the SAN connection device 4 via the LAN connection device 5, and can acquire the state of each device. It is assumed that the network 6 is a network in which the storage device 2A, the host computers 3A and 3B, and the storage device 2B, the host computers 3C and 3D are mutually connected, and it is assumed that both the LAN communications and SAN communications are included. As shown in FIG. 1, the network 6 may be physically split or may be logically split.

Further, for example, the storage device 2A, the host computer 3A, and the host computer 3B are installed in a same spot (site). On the other hand, it is assumed that the storage device 2B, the host computer 3C, and the host computer 3D are installed on a different spot. Therefore, the band of 60A connecting the networks 6A and 6B is assumed to be a wide area network connecting between the data centers, and the environment is such that the band is narrower than the band of the network in the data center in which the host computers 3A and 3B are connected to the storage device 2A, and therefore the network configuration becomes non-uniform.

In such an environment, the virtual disk (VD) 61 is stored in the volume 241A, and the volume 241A is paired as a copy pair with the volume 241B. Further, the stored information is copied by the copy pair management program 2416 of the storage devices 2A and 2B. Although both the volumes 241A, and 241B are accessible from the host computers 3A, 3B, 3C and 3D, the volumes 241A, and 241B are recognized as a same volume by the multipath I/O program of the host computer 3, and control is performed so that the volume 241A is accessed in the normal time. The access control as the above may be performed with the storage device being the subject by an ALUA (Asymmetric Logical Unit Access), and may be implemented by the setting of the multipath I/O program.

The virtual machine (VM) 7 that operates by utilizing the virtual disk 61 stored in the volume 241 comprises the host computer 3 that can connect to the volume 241. The host computers 3C, 3D can also access the storage device 241A via the wide area network 60A, whose band is narrow, however, and the host computers 3C, 3D can operate the virtual machine 7. In order to achieve load distribution and availability improvement of each site, the host computers 3A, 3B, 3C and 3D can constitute a cluster. However, where the access to the volume is from 241A and more virtual machines 7 are disposed in the host computers 3C, 3D residing in the site 2, it results in pressuring the wide area network 60A. Therefore, upon organizing a cluster, more host computers are disposed in the site 1 (for example, 3A, 3B) and less host computers are disposed in the site 2 (for example, 3C alone). By this, even if a gadget is implemented that automatically balances the load on the host computer 3 in the cluster by migrate of the virtual machine, the number of virtual machines operating in the site 1 is consequently the greater. Therefore, it becomes possible to achieve less use of the band of the wide area network.

In the environment as the above, where a fault occurs in the storage device 2A, since it becomes not possible to perform reading and writing against the volume 241A from the host computer 3, changeover to 241B is performed by the multipath I/O program of the host computer 3.

Where the volume of access destination is changed over by switching the primary and secondary states of the copy pair after the fault occurrence in the storage device 2A, if access to the volume 241B is to be performed by the host computers 3A and 3B, even before access performance degradation actually takes place, access to the volume 241B via the wide area network 60A increases, and the band of the wide area network 60A is pressured. This is because a greater number of host computers in the site 1 is included in the cluster. Therefore, consequently, performance of the virtual machines 7 operating in the host computers 3A and 3B will decline. In order to avoid such performance degradation, in the present embodiment the state of the copy pair is monitored, and where it is detected that the primary and secondary states is changed over between storage devices, the allocation of the virtual machine 7 is planned again in consideration of the band of the wide area network 60A, cluster allocation of the host computer 3 is changed according thereto, and migrating of the virtual machine 7 is preformed. By implementing the process as the above, it becomes possible to maintain high availability where a fault has occurred in the storage device 2, while suppressing the performance degradation of the virtual machine 7.

### (ii) FIG. 25B

FIG. 25B shows an example of a system in which both primary and secondary volumes can accept an access from a host computer. The I/O issued from the virtual machine operating in the host computer 3A is accessed by the volume 241A of the storage device 2A via the network 6A, and the I/O issued by the virtual machine operating in the host computer 3C is accessed by the volume 241B of the storage device 2B via the network device 6B. For each I/O, data copying is performed by synchronization control between the storage devices at an appropriate timing so that the consistency of data stored in the volumes can be maintained.

Also in such an environment, where a fault occurs in the storage device 2A, the state of the volumes becomes the non-paired state, reading and writing from the host computers 3A and 3B against the volume 241A becomes not possible, and the access destination is changed over to 241B by the multipath I/O program of the host computer 3.

Where after a fault has occurred in the storage device 2A, a volume of the access destination is changed over, when access to the volume 241B is performed from the host computers 3A and 3B, access to the volume 241B via the wide area network 60A increases and the band of the wide area network 60A will be pressured even before actually the access performance degradation takes place. This is because the host computer of the site 1, having accessed the volume 241A of the site 1 until then accesses the volume 241B of the site 2 via the wide area network 60A. Accordingly, as a result, the performance of the virtual machines 7 operating in the host computers 3A and 3B will decline. In order to avoid performance degradation, the present embodiment, in the same manner as stated above, monitors the state of the copy pair, and where it is detected that the volume of the access destination is changed over, considers the band of the wide area network 60A, again plans the allocation of the virtual machine 7, changes cluster allocation of the host computer 3, according thereto, and migrates the virtual machine 7. By implementing the process, it becomes possible to suppress the performance degradation of the virtual machine 7 while maintaining high availability at the time when there is a fault in the storage device 2.

### <Storage Fault Handling Process>

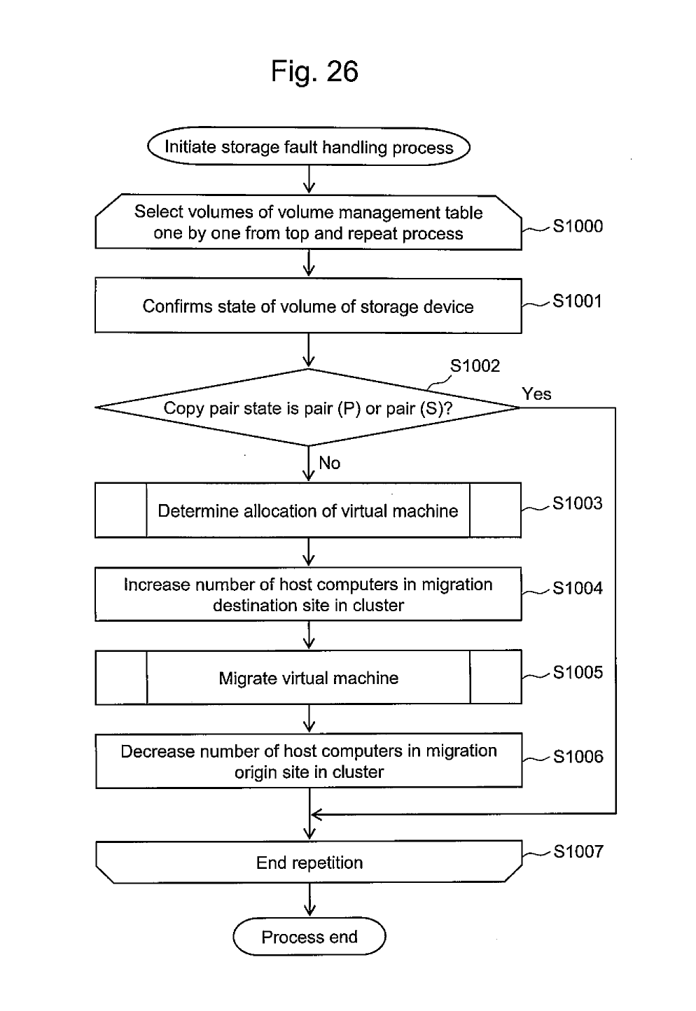

FIG. 26 is a flowchart for explaining an example of storage fault handling process of the management computer 1 in the environment of FIGS. 25A and B.

The storage management program 1404 of the management computer 1 when a fault occurs in the storage device 2 and it is detected that it is disabled to access against the volume to which the virtual machine (virtual server) has accessed, selects the entry of the volume management table 1410 (see FIG. 15), repeats the process of S1001 to S1006 sequentially (S1000). This processing is explained as an operation of detecting the state change by monitoring storage devices with a management computer in an appropriate timing. However, this processing may be initiated using as a trigger notifying the state change due to the fault etc from the storage devices to the management computer.

The storage management program 1404 confirms the state of the volume selected as the storage device 2 (S1001). More specifically, the management computer 1 confirms whether the copy pair state is paired by confirming the state of the volume with reference to “state 14103” of the volume management table 1410. Here, the paired state represents a state that the copy pair is normally made. Where a fault has occurred in the volume of the storage device and it is disabled to access the volume, since the state 14103 is transitioned from “paired” to “non-paired,” it will be confirmed that the “paired” state is cancelled as “non-paired.”

The storage management program 1404 determines whether the copy pair state confirmed in S1001 is “pair (P)” or “pair (S)” (S1002). Where the copy pair state is determined to be “pair (P)” or “pair (S),” it is determined that the copy pair is paired and the state is normal. Then, the management computer 1 selects the next volume as the target. On the other hand, where the state of the copy pair is not paired, the process proceeds to S1003.

In S1003, the allocation planning program 1402 of the management computer 1, since the state “non-paired” is the fault state and also the access destination is changed, determines that the state needs relocation of virtual machine, and determines allocation of the virtual machine (S1003). Specifically, the allocation planning program 1402 of the management computer 1 selects entries in which the location 14083 in the virtual machine management table 1408 is “site 1,” and sets migration destination to “site 2” and treats the entry as the target of the migration process, until a value obtained when Disk I/O amount of the migration target is subtracted from the traffic amount of current state of the wide area network is smaller than a threshold.

Next, in S1004, the cluster configuration management program 1401 of the management computer 1 sums the CPU usage amounts, the memory usage amounts of the entry of the virtual machine in which migration destination 14084 of the virtual machine management table 1408 is “site 2.” Further, the cluster configuration management program 1401 selects a host computer in which the location 14072 of the host computer management table 1407 is “site 2,” sums the CPU resource amounts of thereof and sums the memory resource amounts thereof, and input Cls1 in the cluster to which it belongs until each of the total values of the virtual machine entry is exceeded. Then, the host management program 1403 newly adds a host computer that has come to belong to a cluster to the cluster (S1004). For example, where the cluster configuration is as shown in FIG. 12, Hosts 5 and 6 are add to Cls1 (however, Hosts 1 and 2 are excluded from Cls1 in S1006). In such a configuration, an automatic equalization of the load to the host computer which is included in the cluster is sometimes performed by utilizing the feature that a virtual machine can be migrated to an arbitrary host computer in an appropriate timing among host computers which configure the cluster. Thus, if there exist many host computers in a system group (site) which do not have any volumes, the virtual machine is sometimes automatically migrated for the purpose of equalizing the loads of the host computer. To prevent this automatic migration, it becomes possible to operate the cluster configuration simultaneously with the load equalization by excluding Hosts 1 and 2 from Cls1.

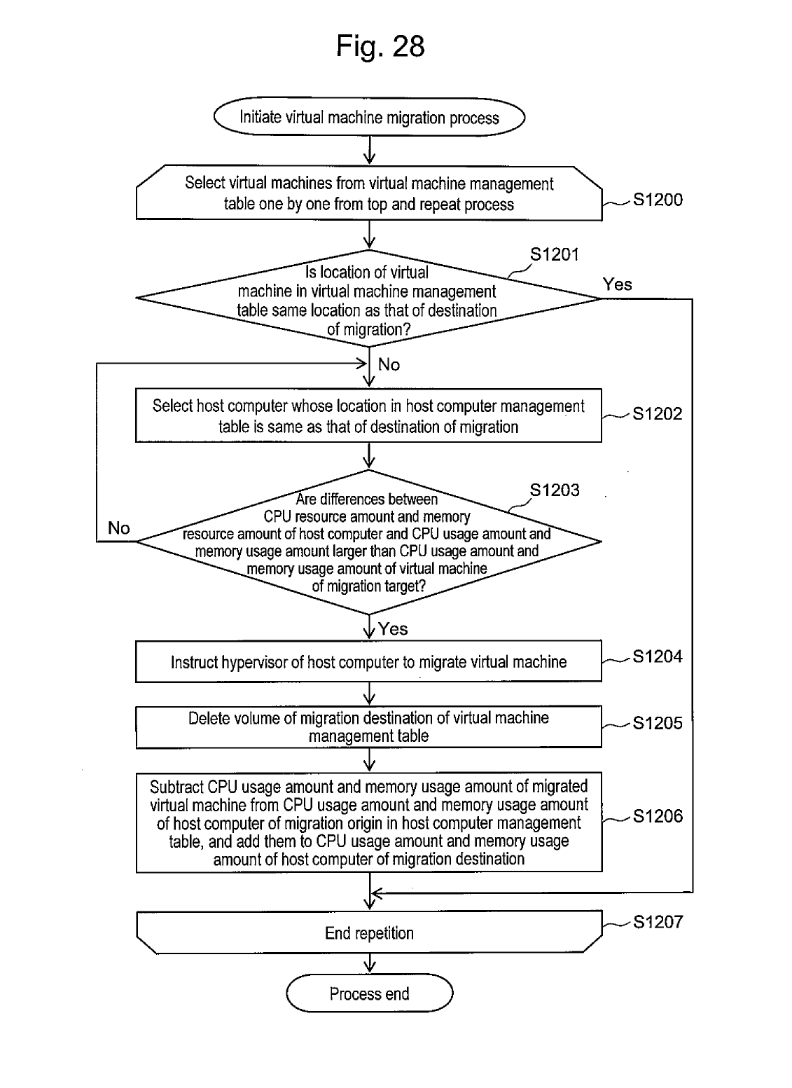

Next, the host management program 1403 selects an entry in which the location 14083 of the virtual machine management table 1408 is different from the migration destination 14084. Then, the host management program 1403 retrieves the host computer 3 corresponding to the site of the migration destination 14084 from the host computer management table 1407, and subtracts the CPU utilization rate and the memory usage amount from the amount of CPU resource and the amount of memory resource, respectively. Further, the host management program 1403 retrieves a host computer that exceeds the CPU usage amount and the memory usage amount of the virtual machine management table 1408 from the host computer management table 1407, and determines it as the migration destination host computer, and migrates the virtual machine to the host computer (S1005). Further details of process in S1005 will be described with reference to FIG. 28.

In the host management program 1403, the location 14083 of the virtual machine management table 1408 retrieves the virtual machine 7 of the site 1 and individually sums the amounts of CPU usage and the amounts of memory usage. Further, in the host management program 1403, the location 14072 retrieves from the host computer management table 1407 the host computer 3 of the site 1, and adds the CPU resource amounts and the memory resource amounts entry by entry, until sums of the CPU usage amount and the memory usage amount of the virtual machine are exceeded. Then, the host management program 1403, for entries thereafter sets the entry of the affiliation cluster to “-” (blank), and instructs the corresponding host computer 3 to delete the entry from the cluster configuration to delete it from the cluster (S1006). For example, as stated above, hosts 1 and 2 are deleted from the cluster Cls1.

The process proceeds to S1000, and a series of the processes are executed against each volume (S1007).

### <Details of Virtual Machine Allocation Determination Process (S1003)>

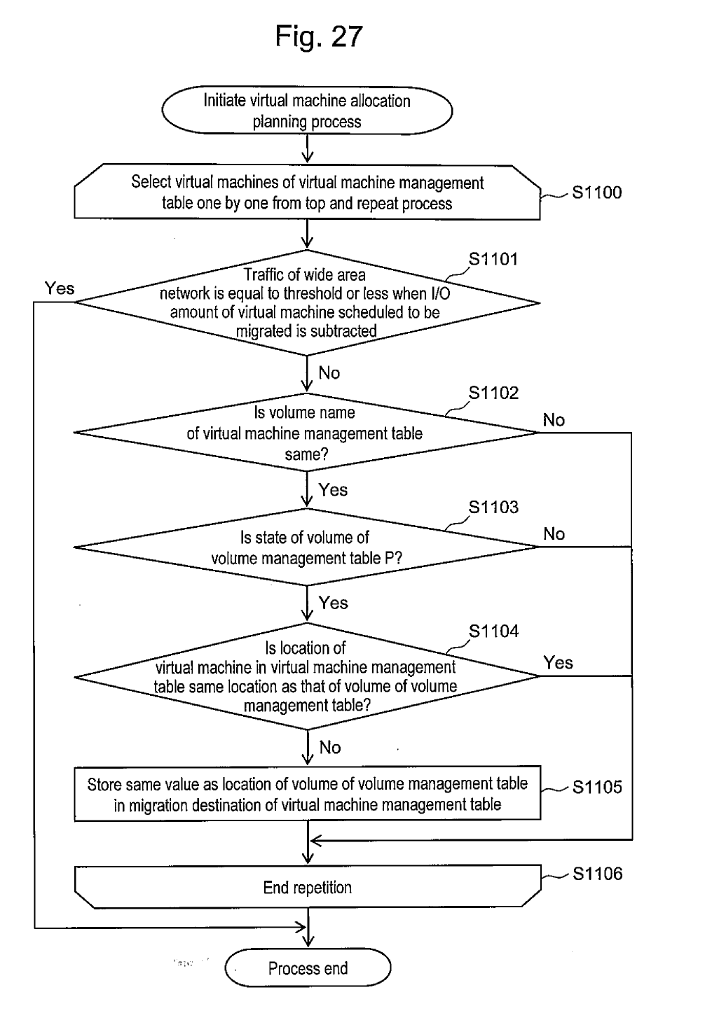

FIG. 27 is a flowchart for explaining the details of the process to determine the allocation of the virtual machines in process S1003 in FIG. 26.

The allocation planning program 1402 of the management computer 1 selects entries of the virtual machine management table 1408 one by one, and initiates a repetition process (S1100).

The allocation planning program 1402 determines whether a value obtained by subtracting the Disk/IO amount of the virtual machine scheduled to be migrated from the usage band 14315 of the wide area network management table 1413 is equal to the congestion threshold 14316 or less (S1101). If the value obtained by subtraction is equal to the congestion threshold or less, the process terminates. If the value obtained by subtraction is greater than the congestion threshold, the process proceeds to S1102.

The allocation planning program 1402 confirms whether the volume name 14086 of the virtual machine management table 1408 is the same as the volume selected in S1000 (S1102). That is, it is checked whether a virtual machine is a virtual machine associated with (accessing) a volume in which a fault has occurred, and only those associated virtual machines are extracted. When the volume is different, the allocation planning program 1402 selects the next entry of virtual machine and continues the process. Where the volume is the same, the allocation planning program 1402 cause the process to proceed to S1103.

In S1103, the allocation planning program 1402 confirms whether the state of volume 14103 of the volume management table 1410 is P (Primary: a state in which reading and writing is possible). That is, it is checked whether the volume that is the access destination of the virtual machine after the fault has occurred is originally P_Vol, and the fault has occurred in S_Vol. Where the state 14103 is not P, the allocation planning program 1402 selects the next entry of virtual machine and continues the process. Where the state 14103 is P, the process proceeds to S1104.

In S1104, the allocation planning program 1402 references the volume management table 1410 and the storage device management table 1409, and the location 14083 of the virtual machine of the virtual machine management table 1408 confirms whether the access destination is the same location as that of the volume (S_Vol) changed over. If they are the same, since there is no need to migrate the virtual machine, the allocation planning program 1402 selects the next entry of virtual machine and the process continues (S1104). If they are different from one another, the process proceeds to S1105.

In S1105, the allocation planning program 1402 stores the same value as the location of the volume of the volume management table 1410 in the migration destination 14084 of the virtual machine management table 1408.

Then, the processes of S1101 to S1105 are repeated until the processes for all the entries of the virtual machine management table 1408 are completed (S1106).

### <Details of Virtual Machine Migration Process S1005>

FIG. 28 is a flowchart for explaining the details of process S1005 that performs migrate of the virtual machine in FIG. 26.

The host management program 1403 of the management computer 1 selects the entries of the virtual machine management table 1408 one by one, and initiates the repetition process (S1200).

The allocation planning program 1402 confirms whether the location 14083 of virtual machine of the virtual machine management table 1408 is the same as the migration destination 14084 (S1201). If they are the same, the allocation planning program 1402 selects the next entry of virtual machine and the process is continued. This is because if they are the same, there is no necessity to migrate the virtual machine. If they are different, the process proceeds to S1201.

In S1201, the allocation planning program 1402 selects a host computer in which the location 14072 in the host computer management table 1407 is the same as the migration destination 14084 in the virtual machine management table 1408.

Next, the allocation planning program 1402 confirms a difference between the CPU resource amount 14074 and the memory resource amount 14075 of the host computer selected in S1201 and the CPU usage amounts 14076 and the memory usage amounts 14077 is larger than the CPU usage amount and the memory usage amount of the virtual machine of the migration target (S1203). In the case of not being larger, the process proceeds to S1202 in order to select another host computer (S1203). In the case of being large, the process proceeds to S1204.

In S1204, the allocation planning program 1402 instructs the hypervisor of the host computer to migrate the virtual machine.

Next, the allocation planning program 1402 deletes the value of the migration destination 14084 in the virtual machine management table 1408 (S1205).

Further, the allocation planning program 1402 subtracts the CPU usage amount and memory usage amount of the migrated virtual machine from the CPU usage amount and memory usage amount of the host computer of the migration origin in the host computer management table 1407, and adds them to the CPU usage amount and the memory usage amount of the host computer of migration destination (S1206).

Then the processes S1201 to S1206 are repeated until the process for the entries of the virtual machine management table 1408 are finished (S1207).

### <Effect According to First Embodiment>

In the first embodiment, a case is assumed where a virtual machine (virtual server) of the host computer (first host computer) of the site 1 (system group 1) accesses to a storage device (site 1: first storage device), the access destination is changed over to a storage device (second storage device) of the site 2 (system group 2) due to a fault of the first storage device. Here, it is assumed that the sites 1 and 2 are connected via a communications network (second kind communications network: a wide area network, such as, the Internet) of a band narrower than a communications network that connects a host computer and a storage device in the site 1 or site 2 (first kind communications network: narrow area communications network, such as LAN and SAN). Here, in response to the changeover, the management computer migrates the virtual machine having operated in the first host computer of the site 1, to the host computer of the site 2 (second host computer). In this way, triggered by access to the access destination being performed via the narrow-band communications network, a virtual server is migrated. Therefore, in addition to being capable of addressing the fault of the storage device, it becomes possible to avoid possible occurrence of bottleneck in the future in a communications network of a narrower band (for example, a wide area network). Further, it becomes possible to reduce the time of performance degradation.

More specifically, the first storage device stores the primary volume (P_Vol), and the second storage device stores a secondary volume (S_Vol) of P_Vol. In this time, in response to turning of the state of P_Vol to the writing impossible state (access is impossible due to a fault of the first storage device), the management computer changes the access destination to the S_Vol of the second storage device from the P_Vol of the first storage device. Then, the management computer migrates the virtual machine operating on the first host computer to the second host computer. In this way, the characteristic of the copy pair is utilized to address the fault of the storage device. In that time, since the virtual server of the access origin is also migrated, it is possible to avoid the access via the narrow-band communications network, and it becomes possible to more certainly ensure continuation of the operation. It is possible, when the fault of the first storage device is removed, to return the access destination to the first storage device from the second storage device so that the migrated virtual machine is again migrated from the second host computer to the first host computer. By this, it is possible to continuously enjoy the benefit of the copy pair. Meanwhile, though the state is changed to non-copy-paired state in the wake of the fault of a storage device, the trigger of changing the copy pair state is not necessarily limited to the fault of a storage device.

When migrating the virtual machine to the second computer, where the second host computer does not belong to a same cluster as the first host computer, the first host computer is removed from the cluster and adding the second host computer to the same cluster instead. By configuring so, it is possible to balance the range of migrate of the virtual machine with another range of the migration of the virtual machine without expanding the range of migration than necessary.

Further, when determining the second host computer that is the migration destination of the virtual machine, a host computer is selected that has margin for the resource amount even when the resource amount used for a virtual machine is added. By configuring so, it becomes possible to avoid an excessive load on the host computer in the migration destination.

### (2) Second Embodiment

Hereafter, for the second embodiment of the present invention, since there are many portions implemented by a same configuration as the first embodiment, the explanation will be given mainly about the different parts.

### <Storage Device Management Table>

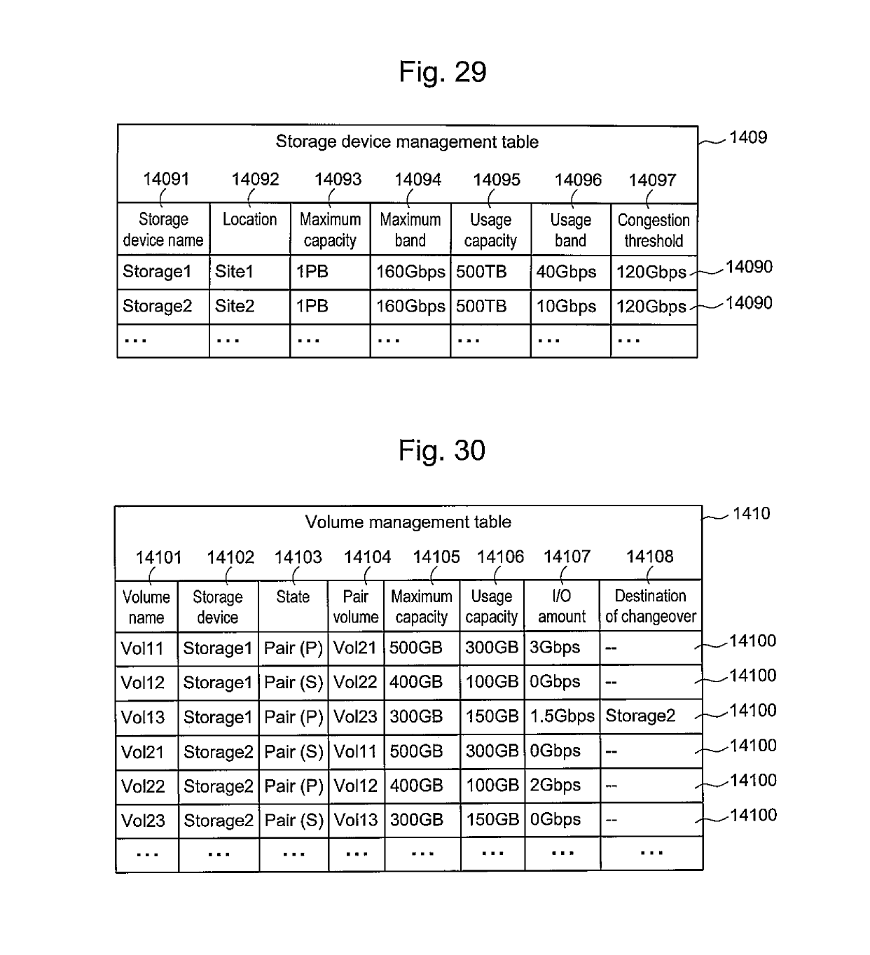

FIG. 29 is a diagram showing one exemplary configuration of a storage device management table 1409 according to the second embodiment. The storage device management table 1409 comprises, for each entry 14090, a band threshold 14097 that is to be an index to detect that the load on each storage device becomes high load state, in addition to the configuration of the storage device management table (FIG. 14) according to the first embodiment, as constituent items.

### <Volume Management Table>

FIG. 30 is a diagram showing one exemplary configuration of a volume management table 1410 of the second embodiment. The volume management table comprises, for each entry 14100, a destination of changeover 14108 that shows a destination of changeover of an access path of each volume, in addition to the configuration of the first embodiment, as constituent items.

### <Logical Configuration of Computer System>

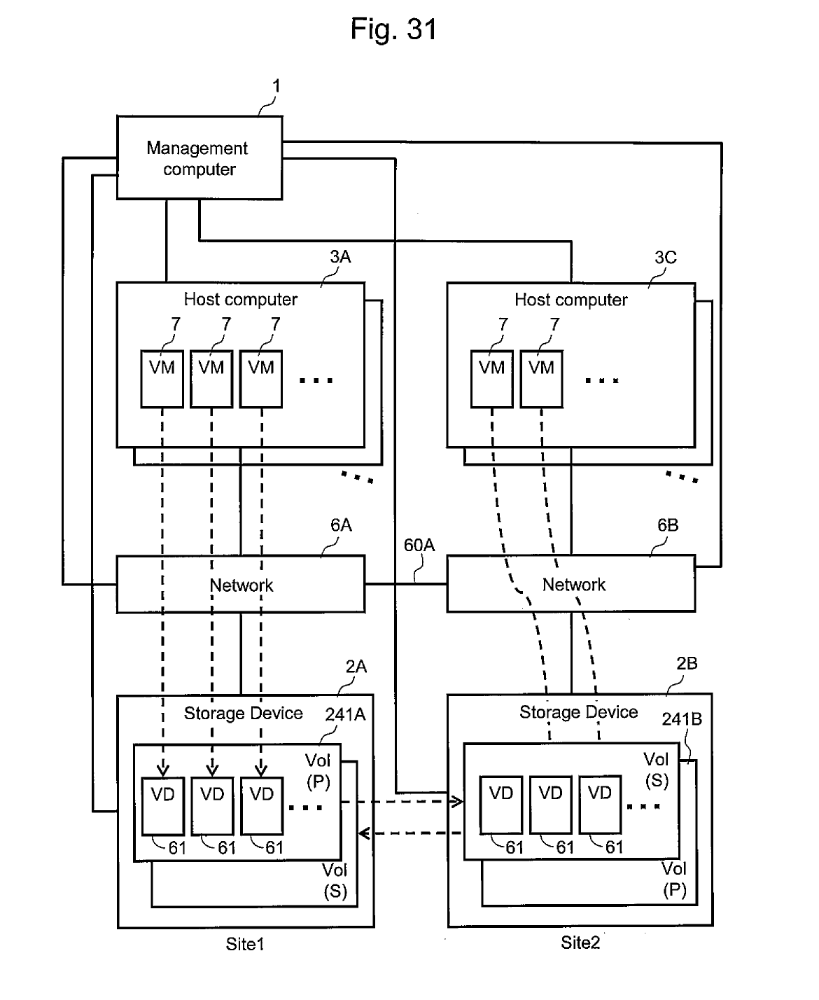

FIG. 31 is a diagram showing an exemplary logical configuration of a computer system according to the second embodiment.

In the computer system of the second embodiment, in order to describe a process targeting load distribution of the storage device, explanation will be given mainly about the difference from the first embodiment. In the volumes 241A, and 241B stored in the storage device 2, a virtual disk utilized by a plurality of different virtual machines is stored.

As shown in FIG. 31, the virtual machine 7 provided on each site has an access destination of the virtual disk 61 of the storage device 2 (2A, 2B, . . . ) on the same site. Accordingly, the state is such that access is not performed from the virtual machine on the one site (system group) to the virtual disk 7 in the storage device on the other site (system group).

In such an environment, in the second embodiment, for example, triggered by being high of the load on the storage device 2A, the access to the volume 241A on which the load is high is changed over to the storage device 2B.

### <Load Distribution Process of Storage Device>

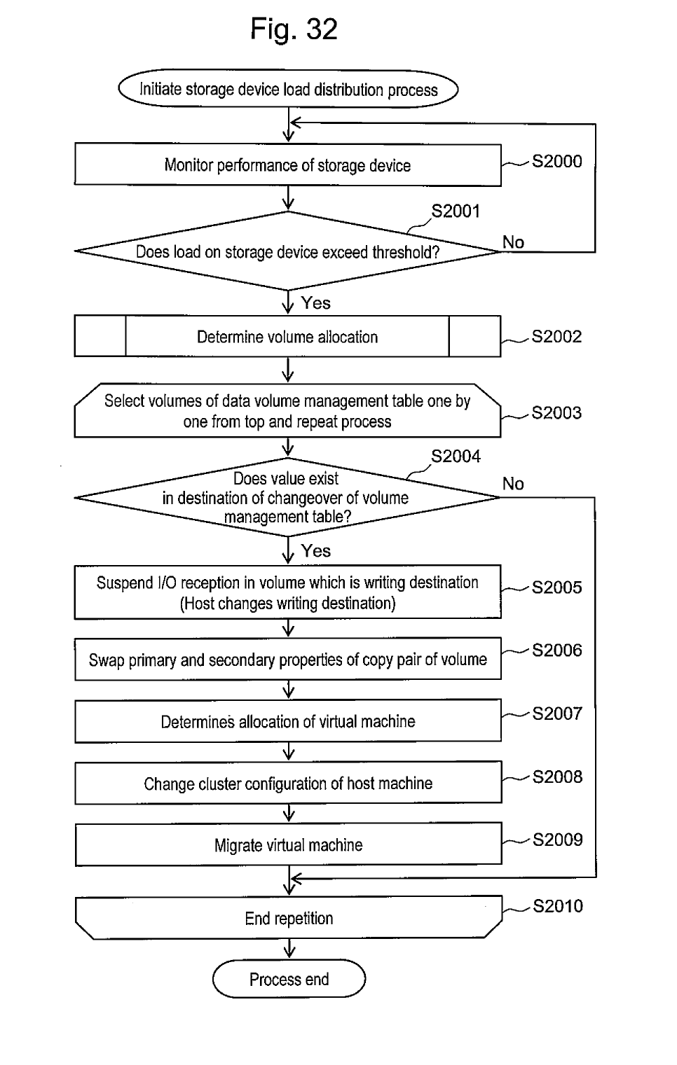

FIG. 32 is a flowchart for explaining an example of load distribution process for the storage device executed by the management computer 1 in the environment of FIG. 31.

The management computer 1 monitors the performance of the storage device 2 (2A, 2B, . . . ) (S2000). Specifically, the management computer 1 queries the storage device 2 for performance information at an appropriate timing, and stores information acquired from the storage device 2 in the usage capacity 14095 or the usage band 14096 of the storage device management table 1409.

The management computer 1 references to the storage device management table 1409 and confirms whether the usage band 14096 of the storage device does not exceed the band threshold 14097 (S2001). If the usage band 14096 does not exceed the threshold 14097, another storage device is selected, and the processes are repeated at appropriate timings. On the other hand, where the load of the storage device exceeds the threshold, the process proceeds to S2002.

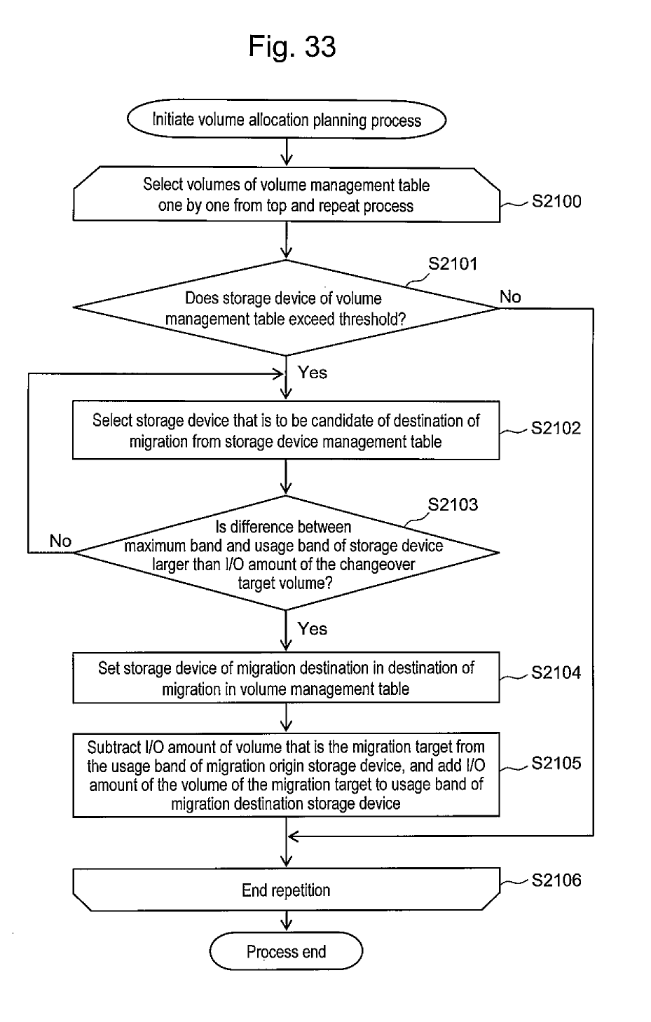

In S2002, the allocation planning program 1402 of the management computer 1 executes a volume allocation determination process. The details of the process S2002 are stated below with reference to FIG. 33.

Next, after allocation of the volume is determined, the allocation planning program 1402 selects entries of the volume management table 1410 (FIG. 30) one by one, and sequentially repeats the process of S2004 to S2009 (S2003).

First, the allocation planning program 1402 confirms whether there is a value in the destination of changeover 14108 of the volume management table 1410 regarding the volume of the processing target (S2004). If there is no value in the destination of changeover, the allocation planning program 1402 terminates the process for the volume that is currently processing target, and selects the next entry. On the other hand, if there is a value in the destination of changeover, the process proceeds to S2005.

The allocation planning program 1402 instructs the storage device 2 to which the volume that is the processing target belongs to suspend I/O reception in the volume which is the destination for writing (S2005).

Then, the allocation planning program 1402, in order to change the destination for writing, swaps the primary and secondary properties of the copy pair for the processing target volume (S2006).

Next, the allocation planning program 1402 determines the allocation of the virtual machine by using the same method as adopted in the first embodiment (see FIG. 27) (S2007).

Next, the allocation planning program 1402 changes the cluster configuration of the host computer according to the allocation of the virtual machine (S2008), and migrates the virtual machine by using the same method as adopted in the first embodiment (see FIG. 28) (S2009).

### <Details of Volume Allocation Planning Process S2002>

FIG. 33 is a flowchart for explaining the details of the process of the volume allocation planning of S2002 in FIG. 32.

The allocation planning program 1402 sequentially repeats the processes of S2101 to 2105 by selecting the entries of the volume management table 1410 one by one (S2100).

First, the allocation planning program 1402 references to the storage device management table 1409 and confirms whether the storage device 14102 of the volume management table 1410 is a device that exceeds the threshold 14097 (S2101). If it is not the device exceeding the threshold, the allocation planning program 1402 terminates the process for the volume of the processing target, and selects the next volume as the processing target. On the other hand, where it is the device exceeding the threshold, the process proceeds to S2102.

In S2102, the allocation planning program 1402, selects the storage device that is to be the candidate of the destination of changeover from the storage device management table 1409. This storage device as the migration destination is selected from one or more storage device containing volumes which are paired up with the volumes in the storage device as the migration origin.

Next, the allocation planning program 1402 confirms whether the value of difference between the maximum band 14094 and usage band 14096 of the storage device selected in S2102 is larger than the I/O amount 14107 of the changeover target volume (whether there is a margin in the storage device) (S2103). If the difference value is not larger than the I/O amount of the changeover target volume, the allocation planning program 1402 proceeds the process to S2102, selects another storage device and repeats the process. On the other hand, where the difference value is larger than the I/O amount of the changeover target volume, the process proceeds to S2104.

In S2104, the allocation planning program 1402 sets the changeover destination storage device as the destination of changeover in the volume management table 1410 (S2104).

Then, the allocation planning program 1402 subtracts the I/O amount of the volume that is the changeover target from the usage band of the changeover destination storage device, and adds the I/O amount of the volume of the changeover target to the usage band of the changeover destination storage device (S2105).

### <Effect of Second Embodiment>

In the second embodiment, a case is assumed where, when the virtual machine (virtual server) of the host computer (first host computer) of the site 1 (system group 1) accesses a storage device (site 1: first storage device) (for example, accesses P_Vol), the load on the first storage device becomes large (exceeds a predetermined threshold), and the access destination is changed over to a storage device (second storage device) of the site 2 (system group 2) (for example, changed over to S_Vol). In this process, similarly to the first embodiment, it is assumed that sites 1 and 2 are connected through the communications network (second kind communications network: a wide area network) of a band narrower than the band of the communications network connecting the host computer and the storage device in the site 1 or the site 2 (first kind communications network: narrow a area communications network). Here, in response to the changeover, the management computer migrates the virtual machine (virtual server) having operated on the first host computer in the site 1 to the host computer in the site 2 (second host computer). In this way, similarly to the first embodiment, in the wake of the event that the copy pair state is changed and the storage device as the access destination is switched to another, the event is detected that access to the access destination has comes to be performed via the narrow-band communications network, and then a virtual server (a virtual machine) is migrated. Therefore, it is possible to ease the load on the storage device, as well as avoiding possible occurrence of bottleneck in the future in the communications network of the narrower band (for example, a wide area network), and it becomes possible to reduce the time duration of performance degradation.

Meanwhile, this embodiment discloses an example of changing over the primary and secondary properties of the copy pair in the wake of increase in load of a volume of the storage device.

### (3) Third Embodiment

The third embodiment relates to a process for implementing the load distribution of the host computer. Hereafter, for the third embodiment of the present invention, since there are many portions implemented by the same configurations as the first embodiment and the second embodiment, explanations will be given mainly of the different portions.

### <Host Computer Management Table>

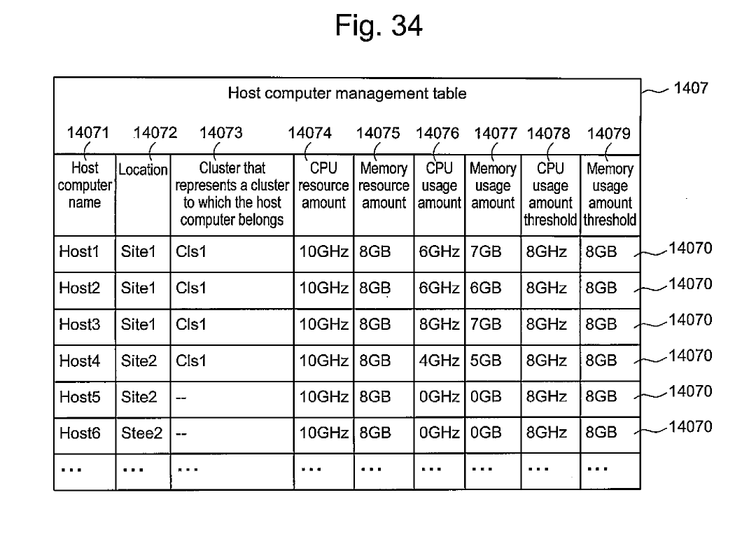

FIG. 34 is a diagram showing one exemplary configuration of a host computer management table 1407 according to the third embodiment. The host computer management table 1407 comprises, for each entry 14070, a CPU usage amount threshold 14078 and a memory usage amount threshold 14079 that are used as indexes to detect that load on a host computer is high, in addition to the configuration of the first embodiment (see FIG. 12), as constituent items.

### <Logical Configuration of Computer System>

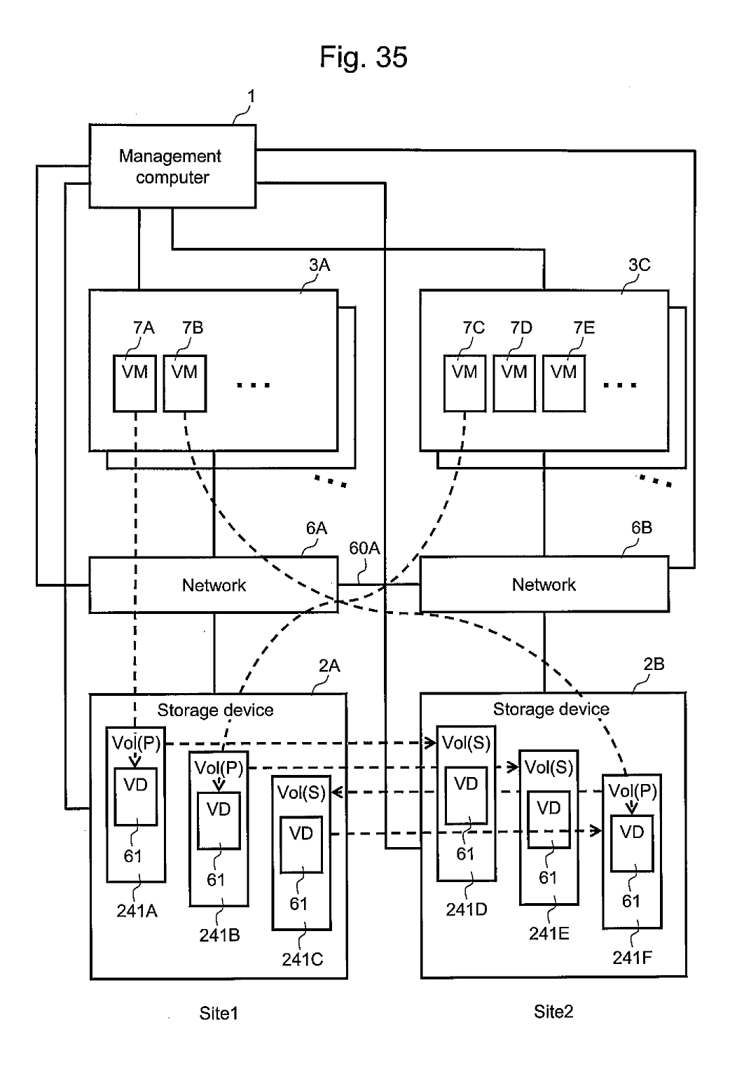

FIG. 35 is a diagram showing an exemplary logical configuration of a computer system according to the third embodiment. In the computer system according to the third embodiment, since a process in which the load distribution of the host computer 3 is the target is executed, explanations will be given mainly of a point of difference from the first embodiment.

In each storage device 2 (2A, 2B, . . . ), a plurality of volumes are stored, and in each volume, one virtual disk utilized in each virtual machine is stored. However, as in the first and second embodiments, a plurality of virtual disk may be stored.

In these environments, triggered by detection of a load on the host computer 3A being high, a virtual machine 7A in which the load is high is migrated, for example, to the host computer 3C. Further, when the host computer 3A is migrated to a host computer of another site in order to reduce the load on the virtual machine, there is a possibility that a bottleneck is caused in the wide area network 60A, leading to the performance degradation as stated above. Then, in order to cut the usage band of the wide area network 60A, a process for changing the allocation of the volume over from the storage 2A to the storage device 2B is executed along with the migrate of the virtual machine.

### <Host Computer Load Distribution Process>

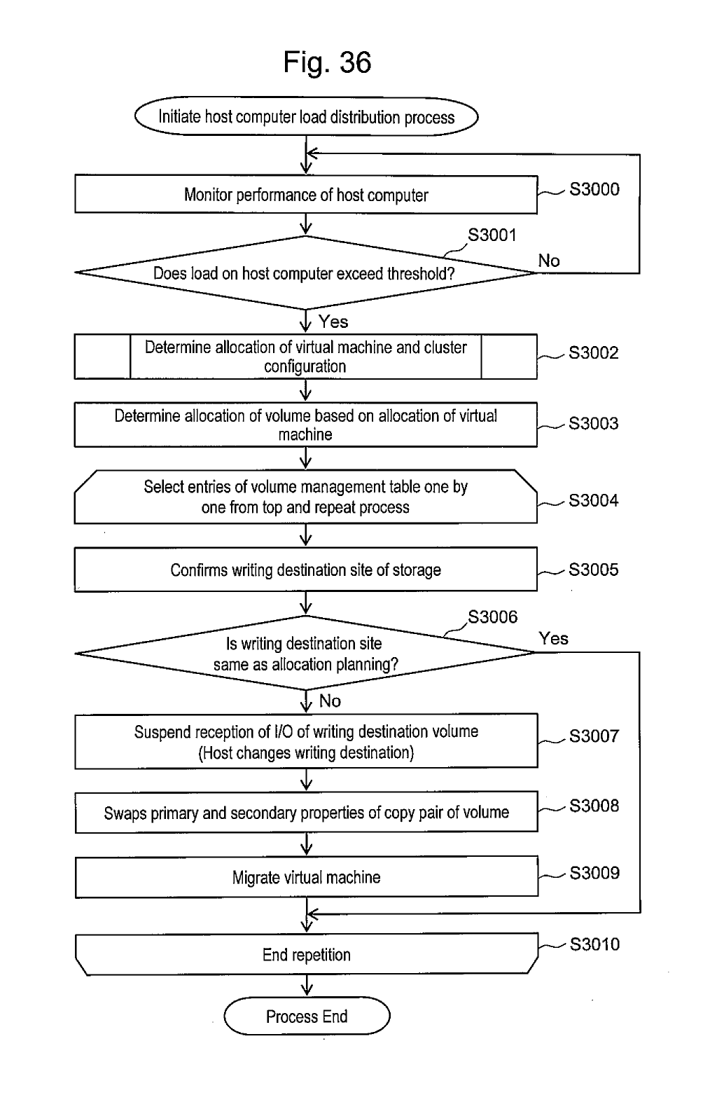

FIG. 36 is a flowchart for explaining an example of the host computer load distribution process according to the third embodiment.

The host management program 1403 of the management computer 1 monitors the performance of each host computer 3 (3A, 3B, . . . ) in cooperation with the performance monitoring program 342 of the host computer 3 (S3000).

The host management program 1403 confirms whether the load of the host computer 3 exceeds a threshold (CPU usage amount threshold 14078 and memory usage amount threshold 14079) (S3001). Where the load does not exceed the threshold, the host management program 1403 selects the next host computer. On the other hand, where it exceeds the threshold, the process proceeds to S3002.

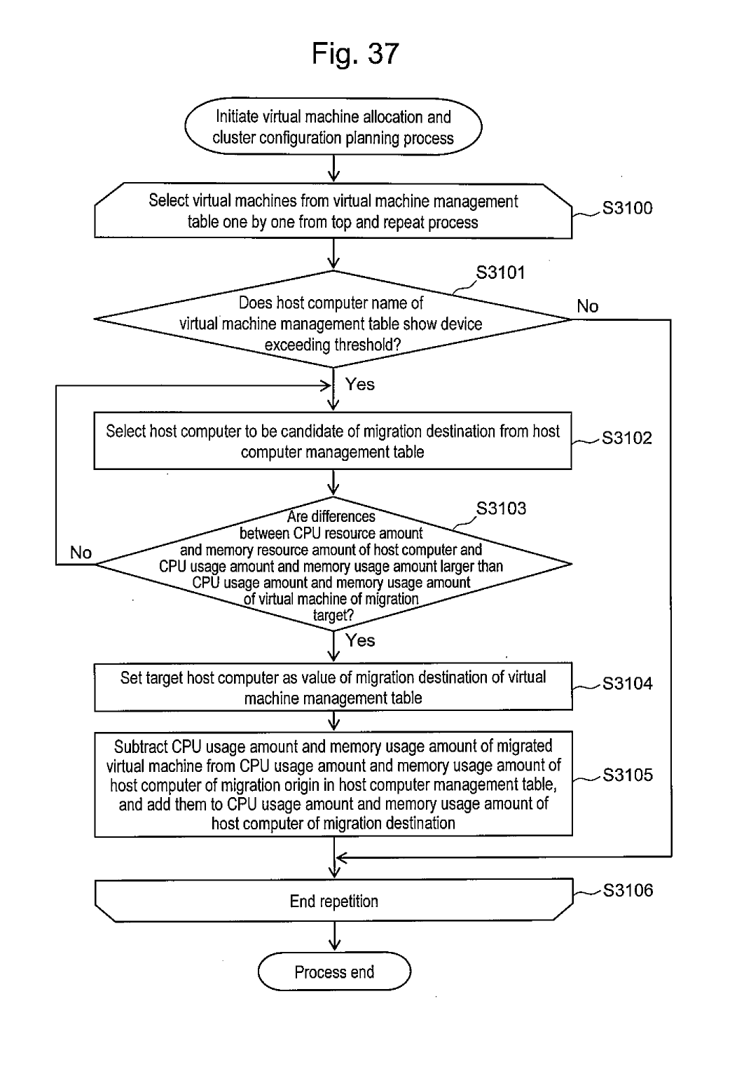

In S3002, the allocation planning program 1402 of the management computer 1 determines cluster configuration and the allocation of the virtual machine (S3002). The details of the process of S3002 will be stated below with reference to FIG. 37.

The allocation planning program 1402 determines the allocation of the volume based on the allocation of the virtual machine (S3003). That is, where the allocation is determined such that the virtual machine is migrated to a host computer of another site (another system group) by the process of S3002, the volume to be used by the virtual machine will be relocated so that the volume to be used by the virtual machine is the same as the allocation of virtual machine (same site).

The allocation planning program 1402 selects entries of the volume management table 1410 one by one, and sequentially initiates the repetition process of S3005 to S3009 (S3004).

First, the allocation planning program 1402 references to the volume management table 1410 and the storage device management table 1409, and confirms the writing destination site of the storage device to which the volume that is the processing target belongs (a site to which a volume in which current data is written belongs) (S3005).

Next, the allocation planning program 1402 confirms whether the confirmed writing destination site is the same as the allocation planning (S3006). If, as a result of confirmation, they are the same, the allocation planning program 1402 proceeds to the process of the next entry. If, as a result of confirmation, the confirmed writing destination site is not the same as the allocation planning, the process proceeds to S3007.

Then, the allocation planning program 1402 stops reception of the volume I/O on the writing destination (S3007), swaps the primary and secondary properties of the copy pair of the volume (S3008), and migrates the virtual machine to the host computer of the determined migration destination (S3009).

### <Details of the Virtual Machine Allocation and Cluster Configuration Plan Process S3002>

FIG. 37 is a flowchart for explaining the details of the processes of the virtual machine allocation and cluster configuration plan process S3002 in FIG. 36.

The allocation planning program 1402 selects the entries in the virtual machine management table 1408 one by one, and initiates the repetition process of S3101 to S3105 sequentially (S3100).

First, the allocation planning program 1402 references to the host computer management table 1407 (FIG. 34), and confirms whether the host computer name 14082 of the virtual machine management table 1408 is a device that exceeds the threshold (CPU usage amount threshold 14078 and memory usage amount threshold 14079) (S3101). If the device is not a device exceeding the thresholds, the process is caused to proceed to the next entry by the allocation planning program 1402. If the device exceeds the threshold, the process proceeds to S3102.

In S3102, the allocation planning program 1402 selects a host computer (any one) that is to be the candidate of the migration destination of the virtual machine from the host computer management table 1407 (S3102). However, host computers one of which is to be selected as the migration destination are accessible host computers which are connected to at least one of a volume in which data of the virtual machine is stored and a copy pair of the volume in which the data of the virtual machine is stored. Further, the load distribution of the virtual machine in the same site is performed routinely, it is preferable that for the host computer to be selected as a candidate, a host computer of a site that is different from the site in which a host computer for which the virtual machine is currently installed exists is selected.

Next, the allocation planning program 1402 confirms whether each of the value of difference between the CPU resource amount and the CPU usage amount of the host computer and the difference between the memory resource amount and the memory usage amount of the host computer is larger than each of the CPU usage amount and the memory usage amount of the virtual machine (S3103). Where the difference value is not larger than the CPU usage amount and the memory usage amount of the virtual machine that is the migration target, the allocation planning program 1402 causes the process to proceeds to S3102 in order to select another host computer. On the other hand, where the difference value is larger than the CPU usage amount and the memory usage amount of the virtual machine that is the migration target, the process proceeds to S3104.

In S3104, the allocation planning program 1402 sets the target host computer as the value of the migration destination 14084 in the virtual machine management table 1408 (S3104).

Next, the allocation planning program 1402 subtracts the CPU usage amount and the memory usage amount of the virtual machine to be migrated from the CPU usage amount 14076 and the memory usage amount 14077 of the host of the migration origin in the host computer management table 1407, respectively, and adds them to the CPU usage amount 14076 and the memory usage amount of the host of the migration destination, respectively (S3105).

### <Effect of Third Embodiment>

In the third embodiment, a case is assumed in which, when the virtual machine (virtual server) of the host computer (first host computer) of the site 1 (system group 1) accesses a storage device (site 1: first storage device) (for example, accesses P_Vol), the load on the first host computer becomes large (exceeding a predetermined threshold), the virtual machine is migrated to the host computer (second host computer) of the site 2 (system group 2). Here, in the same way as the first embodiment, it is assumed that the sites 1 and 2 are connected in the site 1 and site 2 via a communications network (second kind communications network: wide area network) of a band narrower than the communications network that connects the host computer and the storage device (first kind communications network: narrow area communications network). In this time, in response to the changeover, the management computer changes the access destination over to the storage device in the site 2 (second storage device) from the first storage device in the site 1 (for example, changeover the access destination to S_Vol). That is, along with the migrate of the virtual machine, the access destination is also changed over so as to be within the same site (same system group). In this way, triggered by migrating of the virtual machine to another host computer connected with the host computer via the communications network of a narrow-band in which the virtual machine of the access origin is initially set, the storage device of the access destination is also changed over to a storage device connected to the host computer of the migration destination of the virtual machine via a communications network of a wider band. Therefore, in the same way as the first embodiment it becomes possible to reduce the load on the host computer and avoid a possible occurrence of bottleneck in the future in a communication network of a narrower band (for example, a wide area network). Further, it becomes possible to reduce the time duration of performance degradation.

In the case of changing over the access destination, S_Vol of the second storage device may be set to P_Vol and P_Vol of the first storage device may be again set to S_Vol, and copy pairs may be appropriately swapped. By this, along with the change of host computer of the access origin, it becomes possible to changeover the access destination permanently, not in the manner of emergency escape, irrespective of the load on the first storage device. Therefore, it becomes possible to more flexibly operate the computer system. However, instead of swapping the primary and secondary properties of the copy pair, volume in the changeover destination may be used as S_Vol as is.

### (4) Fourth Embodiment

The fourth embodiment of the present invention relates to a process of migrating a physical server along with a volume changeover (for example, volume changeover due to the occurrence of a fault and volume changeover for load distribution) in the access destination in the storage device 2. As for the fourth embodiment, since there are many portions implemented by the same configurations as first to third embodiments, explanations are given mainly about the different portions.

### <Virtual Machine Management Table>

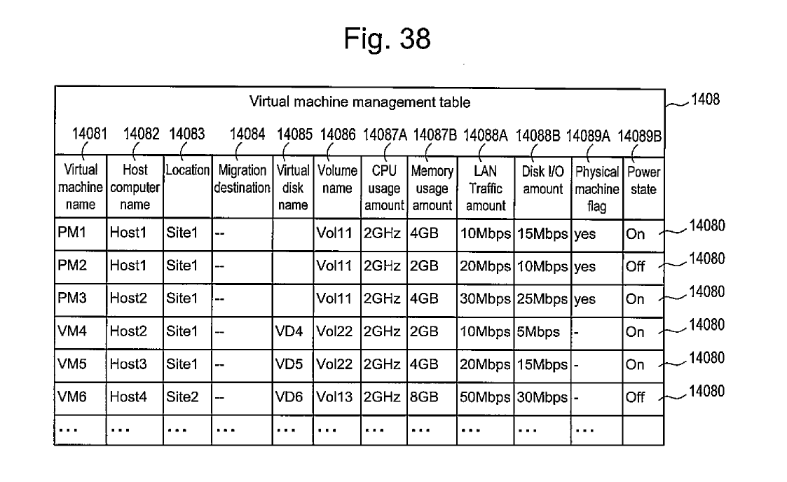

FIG. 38 is a diagram showing one exemplary configuration of a virtual machine management table 1408 according to the fourth embodiment. The virtual machine management table 1408 comprises, for each entry 14080, a physical machine flag 14089A of each virtual machine, a power supply state 14089B as constituent items, in addition to the configuration of the first embodiment, and is a table for managing not only the virtual machine, but also a physical machine (physical server: one host computer constitutes one physical server). Here, the physical machine flag 14089A is a flag showing whether the concerning host computer is such a host computer in which no virtual machine is generated and that operates as the single entirety of a physical machine. Where the flag is “yes,” it means that the host computer is such one that operates as the single entirety of the physical machine.

### <Logical Configuration of Computer System>

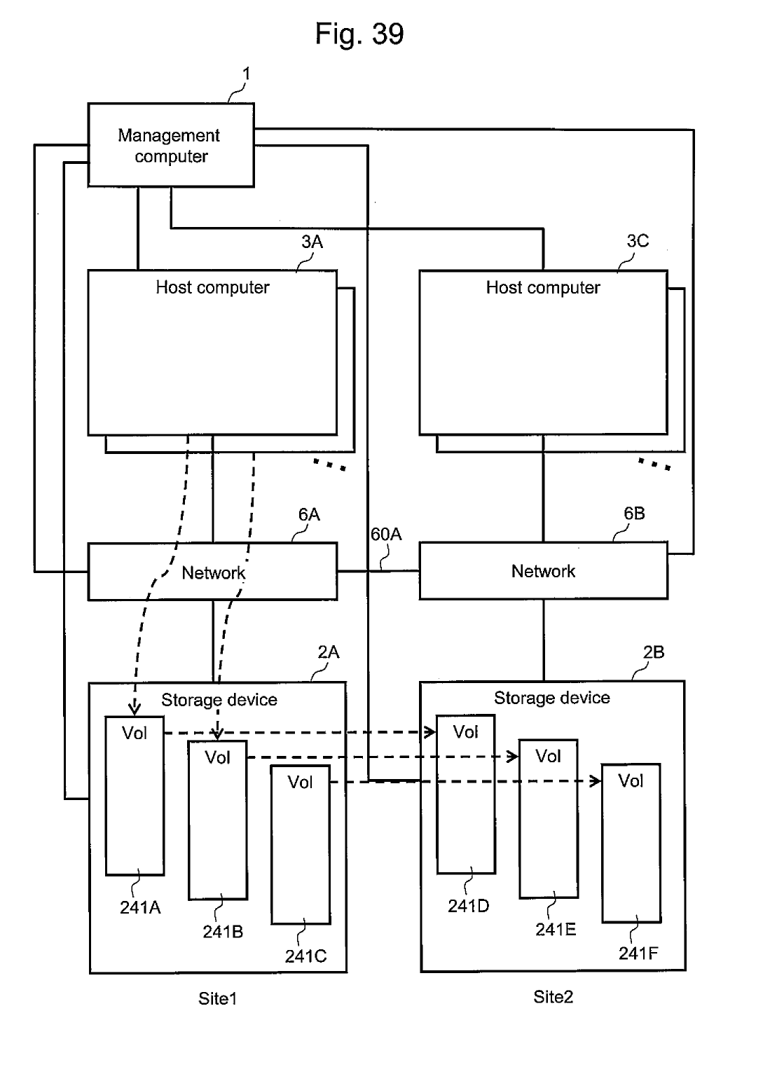

FIG. 39 is a diagram showing a logical configuration of a computer system according to the fourth embodiment.

In the computer system of the fourth embodiment, an OS operating on the host computer 3A is stored in the volume 241A of the storage device 2A, and the host computer 3A activates it via the SAN connection device (included in the network 6). In the volume 241A and the volume 241B of the storage device 2A, data is copied and stored in the volume 241D and volume 241E via the networks 6A, 60A at appropriate timings. In this time, when a fault has occurred in the storage device 2A, the access destination fails over to the storage device 2B, and the access destination of the volume is changed from 241D to 241A, the physical host computer 3A that is the access origin is changed to the physical host computer 3C. Hereafter, the process will be described.

### <Storage Fault Handling Process>

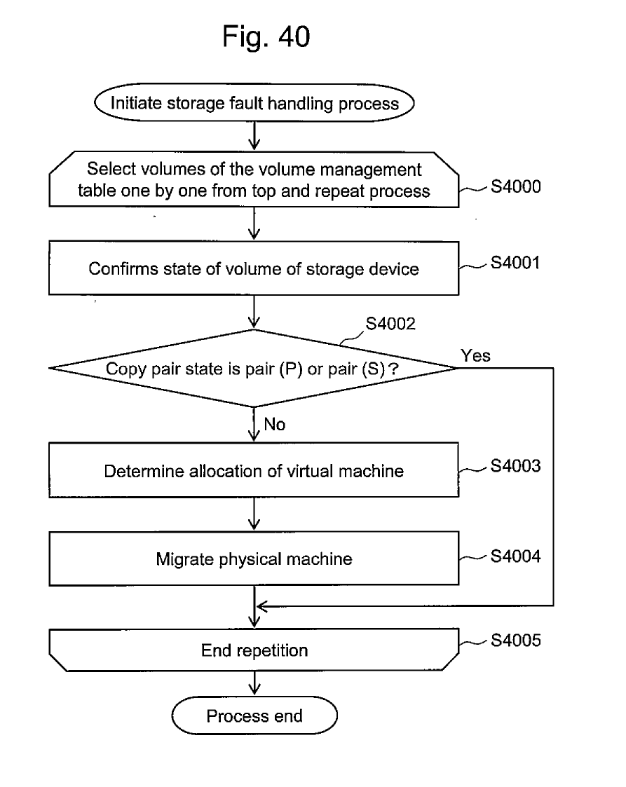

FIG. 40 is a flowchart for explaining an example of the storage fault handling process executed when a fault has occurred in a storage device and the volume of access destination is changed over. Here, although the explanation is given as the handling process on occurrence of a fault, a case where the volume of the access destination is changed over for load distribution of the storage can be explained by the same process.

The storage management program 1404 of the management computer 1 selects entries of the volume management table 1410 one by one, and initiates the repetition process from S4000 to S4005 (S4000).

The storage management program 1404 queries the state of the selected volume against the storage device 2 (volume management program 2412) and confirms the state of the selected volume (S4001).

Next, the storage management program 1404 confirms whether the state 14103 (copy pair state) of the selected volume is “paired (P)” or “paired (S)” (S4002). Here, the state “paired (P)” or “paired (S)” state represents a state in which the copy pair is normality made. Where the state 14103 is “paired (P)” or “paired (S)” and normal, the storage management program 1404 selects the next volume as the processing target. On the other hand, where the state 14103 is not “paired (P)” or “paired (S),” the storage management program 1404 determines that the state is non-paired or a state of fault, and relocation is necessary, and causes the process to proceed to S4003.

Since relocation of a virtual/physical machine will be necessary where abnormality has occurred in the copy pair, the allocation planning program 1402 of the management computer selects entries in which the location 14083 of the virtual machine management table 1408 is “site 1” one by one, and sets the migration destination 14084 to “site 2,” to set the virtual machines as migration targets (S4003).

The host management program 1403 of the management computer 1 executes a process of migrating the physical host computer (S4004). More specifically, the host management program 1403 references to each entry of the virtual machine management table 1408, selects a virtual machine in which information is stored in the migration destination 14084 (for example one in which, “site 2” is set in the cell of the migration destination 14084 in S4003). Here, the host management program 1403 confirms the physical machine flag 14089A and confirms that the power supply state 14089B of the host computer is off for those whose values are “yes.” If the power is on, the host management program 1403 sends a power off instruction to the host computer that is the migration target, and waits until the power is turned off. In this time, timing of power off may be scheduled according to the state of the application operating on the OS. When it is confirmed that the power supply is off state, the host management program 1403 retrieves a host computer that accesses the volume 241A and 241D from the host computer management table 1407. Further, the host management program 1403 references to information of the migration destination 14084 of the virtual machine management table 1408 to retrieve the host computer existing in the same location by referencing to the location 14072 of the host computer management table 1407. Then, the host management program 1403 retrieve a host computer of the same location 14072 and a cluster 14073 to which it belongs is “-” (not belonging to any cluster), and determines it as the host computer of migration destination. Here, the host management program 1403 disables the access to the volume 241A from the host computer 3A of the migration origin, and on the other hand, enables the access from the host computer 3C of the migration destination. This setting can be performed by an appropriate method, such as, the port setting, LUN security setting of the storage device 2(2A, 2B, . . . ) and zoning setting of the SAN connection device 4.

When S4004 is terminated, a series of processes of S4001 to S4004 are repeatedly performed on each volume (S4005).

### <Effect of Fourth Embodiment>

The fourth embodiment assumes a case in which, when the host computer (first host computer) of the site 1 (system group 1) accesses a storage device (site 1: first storage device) (for example, accesses P_Vol) as a physical server, the access destination is changed over to a storage device (second storage device) of the site 2 (system group 2) by a fault of the first storage device (for example, changed over to S_Vol). Here, in the same way as the first embodiment, the sites 1 and 2 are connected via a communications network (second kind communications network: wide area network) of a band narrower than a communications network (first kind communications network: narrow area communications network) connecting the host computer and the storage device in the site 1 or the site 2. In this time, in response to the changeover, the management computer migrates physical server of the first host computer so that the physical server of the site 1 can operate on the host computer of the site 2 (second host computer). In this way, triggered by access to the access destination being performed via the narrow-band communications network, the physical server is migrated. Therefore, it is possible to address the fault of the storage device, as well as avoiding possible occurrence of bottleneck in the future in the communications network of the narrower band (for example, a wide area network). Further, it becomes possible to reduce the time duration of performance degradation. The changeover of the storage device may be performed not only on the occurrence of fault, but also may be performed when the load on the storage device becomes large as in the second embodiment. Further, where the load on the physical server becomes large, the physical server may be migrated to another host computer as in the third embodiment, and the storage device of the access destination may be changed over by being triggered by the migrate.

### (5) Others

The present invention may be implemented by a program code of software that achieves the functions of the embodiments. In this case, a memory media recording a program code is provided on a system or a device, and the computer of the device of the system (or CPU or MPU) may read out the program code stored in the memory media. In this case, the program code itself read from the memory media achieves the functions of the above-described embodiments, and the program code itself and the memory media storing it constitutes the present invention. As a memory media for supplying the program code, for example, a flexible disk, CD-ROM, DVD-ROM, a hard disk, an optical disk, a magneto-optic disk, CD-R, a magnetic tape, a nonvolatile memory card, ROM, etc., may be used.

Further, an OS (operating system), etc. operating on a computer performs a part or whole of the actual processes based on the instructions of the program code, and the functions of the above-described embodiments may be implemented by the processes.

Further, by distribution of a program code of software implementing the functions of the embodiments via a network, it may be stored in a storage means such as a hard disk or memory of a system or a device, or memory media such as CD-RW, and CD-R, etc., and the program code stored on the storage means or in the memory media may be read by the computer (or CPU or MPU) of the system or device on use and executed thereby.

Finally, the processes and techniques stated herein are not associated with specific device essentially, and it is necessary to understand that they can be implemented on any suitable combination of the components. Further, devices of various types for general-purpose may be used according to the teaching described herein. It may turn out that it is helpful to build a dedicated device in order to execute the steps of the method described herein. Further, by appropriate combination of a plurality of elements disclosed in the embodiments, it is possible to form various inventions. For example, several elements may be deleted from all the elements shown in the embodiments. Further, components in different embodiments may be appropriately combined. Although the present invention has been described in association with specific examples, they are in all respects for explanations, not limitation. Those skilled in the art in the present field may understand that there are many combinations of hardware, software, and firmware that are befitting to implement the present invention. For example, the described software may be implemented by a wide range of program or script languages including assembler, C/C++, Perl, Shell, PHP, Java (registered trademark).

Further, the control lines and information lines shown in the above-stated embodiment are necessary for the explanation purpose, and not necessary all the control lines and information lines on a product are shown. All the configurations may be mutually connected.

In addition, for those having ordinary knowledge in the present technical field, other implementation of the present invention are clear from the discussions disclosed in the specification and embodiments of the present invention. Various aspects and/or components described in the embodiments may used solely or in any combination in a computerized storage system having a function to manage data. The specification and the examples show no more than typical examples, and the scope and the spirit of the present invention is shown in the claims indicated hereinbelow.

### REFERENCE SIGNS LIST

1 Management computer
2 Storage device
3 Host computer
4 SAN connection device
5 LAN connection device

1. A system management method of managing a process in a plurality of storage devices and a plurality of host computers with a management computer,
wherein the management computer comprises a memory that stores predetermined management information, and a processor that reads the predetermined management information from the memory and that manages a process in the host computer and the storage device by using the predetermined management information,
a copy pair is created between a storage area of a first storage device and a storage area of a second storage device, and
duplicate data of data stored in the storage area of the first storage device is stored in the storage area of the second storage device, the method comprising the steps of:
the processor, triggered by an event that a copy pair state has been changed between the storage areas of the first and second storage devices, changing over an access destination of a first host computer from the storage area of the first storage device which is connected to the first host computer via a first communications network to the storage area of the second storage device which is connected to the first host computer via a second type communications network; and,
the processor changing over an access origin of the second storage device from the first host computer to a second host computer connected to the second storage device via the first type communications network to the second storage device.

2. A system management method according to claim 1, wherein
the access origin is a virtual machine, and the processor change over the access origin by migrating the virtual machine which operates in the first host computer, to the second host computer.

3. A system management method according to claim 1, wherein
the change of the copy pair state which is a trigger of changing over the storage area corresponds to an event that the copy pair state has been cancelled.

4. A system management method according to claim 1, wherein
the change of the copy pair state which is a trigger of changing over the storage area corresponds to an event that primary and secondary properties of the copy pair has been changed over between the storage areas of the first and second storage devices.

5. A system management method according to claim 2, wherein
a cluster that defines a range of migration of the virtual machine is set up, and
the processor, when migrating the virtual machine to the second computer, excludes the virtual machine on the first host computer from the cluster, and adds the migrated virtual machine on the second computer to the cluster.

6. A system management method according to claim 2, wherein
the processor selects a host computer which has a margin in resource amount thereof even if a resource amount used for the virtual machine is added, as the second host computer in the migration destination of the virtual machine.

7. A system management method according to claim 3, wherein
the processor, in response to excess of the load of the first host computer over a predetermined threshold, migrates a virtual machine operating on the first host computer to the second host computer, while changing the access destination from a primary volume to a secondary volume wherein the primary and secondary volumes constitute the copy pair.

8. A system management method according to claim 1, wherein
the first type communications network is narrow area communications network, and the second type communications network is wide area communications network.

9. A system management method of managing a process in a plurality of storage devices and a plurality of host computers with a management computer,
wherein the management computer comprises a memory that stores predetermined management information, and a processor that reads the predetermined management information from the memory and that manages a process in the host computer and the storage device by using the predetermined management information, a copy pair is created between a storage area of a first storage device and a storage area of a second storage device,
duplicate data of data stored in the storage area of the first storage device is stored in the storage area of the second storage device, and,
a first host computer accesses the first storage device via a first type communications network,
the method comprising the steps of:
the processor, in response to an event that a load of the first host computer has exceeded a predetermined threshold, determining a migration destination of a virtual machine which operates in the first host computer to be a second host computer;
the processor judging whether it is necessary to change an access destination of the virtual machine to be migrated from the storage area of the first storage device to the storage area of the second storage device; and,
the processor migrating the virtual machine from the first host computer to the second host computer.

10. A system management method according to claim 9, further comprising the step of the processor changing over primary and secondary properties of the copy pair between the storage areas of the first and second storage devices based on the judgment that the change of the access destination is necessary,
wherein, in the step of the processor judging, the processor judges it is necessary to change an access destination of the virtual machine to the storage area of the second storage device if an access from the second host computer to the first storage device comes to be performed via a second type communications network that has narrower band than the first type communications network as a result of migrating the virtual machine from the first host computer to the second host computer, and,
in the step of the processor migrating, the processor, triggered by the changing over of the primary and secondary properties of the copy pair, migrates the virtual machine from the first host computer to the second host computer.

11. A computer system comprising a plurality of storage devices, a plurality of host computers and a management computer,
wherein the management computer comprises a memory that stores predetermined management information, and a processor that reads the predetermined management information from the memory and that manages a process in the host computer and the storage device by using the predetermined management information,
a copy pair is created between a storage area of a first storage device and a storage area of a second storage device,
duplicate data of data stored in the storage area of the first storage device is stored in the storage area of the second storage device,
wherein the processor, triggered by an event that a copy pair state has been changed between the storage areas of the first and second storage devices, changes over an access destination of a first host computer from the storage area of the first storage device which is connected to the first host computer via a first communications network to the storage area of the second storage device which is connected to the first host computer via a second type communications network; and,
the processor changes over an access origin of the second storage device from the first host computer to a second host computer connected to the second storage device via the first type communications network to the second storage device.

12. A computer system according to claim 11, wherein
the access origin is a virtual machine, and the processor change over the access origin by migrating the virtual machine which operates in the first host computer, to the second host computer.

13. A computer system according to claim 11, wherein
the change of the copy pair state which is a trigger of changing over the storage area corresponds to an event that the copy pair state has been cancelled.

14. A computer system according to claim 11, wherein
the change of the copy pair state which is a trigger of changing over the storage area corresponds to an event that primary and secondary properties of the copy pair has been changed over between the storage areas of the first and second storage devices.

15. A computer system according to claim 12, wherein
a cluster that defines a range of migration of the virtual machine is set up, and
the processor, when migrating the virtual machine to the second computer, excludes the virtual machine on the first host computer from the cluster, and adds the migrated virtual machine on the second computer to the cluster.

16. A computer system according to claim 12, wherein
the processor selects a host computer which has a margin in resource amount thereof even if a resource amount used for the virtual machine is added, as the second host computer in the migration destination of the virtual machine.

17. A computer system according to claim 13, wherein
the processor, in response to excess of the load of the first host computer over a predetermined threshold, migrates a virtual machine operating on the first host computer to the second host computer, while changing the access destination from a primary volume to a secondary volume wherein the primary and secondary volumes constitute the copy pair.

18. A computer system according to claim 11, wherein
the first type communications network is narrow area communications network, and the second type communications network is wide area communications network.
